(19) United States
(12) Patent Application Publication
(10) Pub. No.: US 2025/0316261 A1
(43) Pub. Date: Oct. 9, 2025

(54) HARDWARE EMBEDDED INFERENCING OF SPEECH RECOGNITION MODEL

(71) Applicant: Intel Corporation, Santa Clara, CA (US)

(72) Inventors: Yaron Klein, Rosh Haayin (IL); Guy Yechezkel Azov, Petach-Tikva (IL); Yuval Vered, Tel-Aviv (IL); Yoni Elron, Hadera (IL)

(73) Assignee: Intel Corporation, Santa Clara, CA (US)

(21) Appl. No.: 19/244,318

(22) Filed: Jun. 20, 2025

Related U.S. Application Data
(60) Provisional application No. 63/698,351, filed on Sep. 24, 2024.

(51) Int. Cl. G10L 15/16

(52) U.S. Cl. CPC G10L 15/16

(57) ABSTRACT

An integrated circuit (IC) device may implement a speech recognition model with a transformer-based architecture. The IC device may include an embedder unit, etched mind unit(s), a layer normalizer unit, a sampler unit, and a flow control unit. The embedder unit may be a hardware implementation of an embedder in the model. The etched mind unit(s) may be a hardware implementation of matrix multiplications and additions in the model. The layer normalizer unit may implement a layer normalizer in the model. The sampler unit may implement a sampler in the model. The sampler unit may use comparators to find the largest value of a vector received from the etched mind unit(s). The sampler unit may determine the index of the largest value and output a predicted token. The flow contour unit may orchestrate the other components of the IC device based on a timing sequence of the model.

### CROSS-REFERENCE TO RELATED APPLICATION

This application claims the benefit of U.S. Provisional Patent Application No. 63/698,351, filed Sep. 24, 2024, and titled “HARDWARE EMBEDDED INFERENCING OF NEURAL NETWORK MODEL,” which is incorporated by reference in its entirety for all purposes.

### TECHNICAL FIELD

This disclosure relates generally to neural networks (also referred to as “deep neural networks” or “DNN”), and more specifically, hardware embedded inferencing of DNNs, such as speech recognition models.

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as there can be a large number of operations as well as a large amount of data to read and write.

### BRIEF DESCRIPTION OF THE DRAWINGS

Embodiments can be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates exemplary data flow in a speech recognition model, in accordance with various embodiments.

FIG. 2 illustrates an exemplary encoder of a speech recognition model, in accordance with various embodiments.

FIGS. 3A and 3B illustrate an exemplary decoder of a speech recognition model, in accordance with various embodiments.

FIG. 4 illustrates an integrated circuit (IC) device that implements a speech recognition model on silicon, in accordance with various embodiments.

FIG. 5 illustrates an embedder unit, in accordance with various embodiments.

FIG. 6 illustrates a layer normalizer unit, in accordance with various embodiments.

FIG. 7 illustrates a sampler unit, in accordance with various embodiments.

FIG. 8 illustrates a convolution unit, in accordance with various embodiments.

FIG. 9 illustrates a sliding window extractor in a convolution unit, in accordance with various embodiments.

FIGS. 10A-10C illustrate a Gaussian Error Linear Unit (GELU) unit, in accordance with various embodiments.

FIG. 11 illustrates a SoftMax unit, in accordance with various embodiments.

FIG. 12 illustrates an embedding dot unit, in accordance with various embodiments.

FIG. 13 illustrates a sequential read-only memory, in accordance with various embodiments.

FIG. 14 illustrates sequential ROMs proximate to multipliers, in accordance with various embodiments.

FIG. 15 illustrates an attention multiplier unit with a sequential read/write memory, in accordance with various embodiments.

FIG. 16 illustrates an exemplary transformer model, in accordance with various embodiments.

FIG. 17 illustrates a first inference phase of a transformer model, in accordance with various embodiments.

FIG. 18 illustrates subsequent inference phases of the transformer model, in accordance with various embodiments.

FIG. 19 is a block diagram of an example computing device, in accordance with various embodiments.

### DETAILED DESCRIPTION

The last decade has witnessed a rapid rise in AI based data processing, particularly based on DNNs. DNNs are widely used in the domains of computer vision, speech recognition, image, and video processing mainly due to their ability to achieve beyond human-level accuracy. A DNN typically includes a sequence of layers. A DNN layer may include one or more operations, such as matrix multiplication, convolution, interpolation, layer normalization, batch normalization, SoftMax operation, pooling, elementwise operation, linear operation, nonlinear operation, and so on. These operations are referred to as deep learning operations or neural network operations.

Neural network operations may be tensor operations. Input or output data of neural network operations may be arranged in data structures called tensors. Taking a convolutional layer for example, the input tensors include an activation tensor (also referred to as “input feature map (IFM)” or “input activation tensor”) including one or more activations (also referred to as “input elements”) and a weight tensor. The weight tensor may be a kernel (a 2D weight tensor), a filter (a 3D weight tensor), or a group of filters (a 4D weight tensor). A convolution may be performed on the input activation tensor and weight tensor to compute an output activation tensor in the convolutional layer.

A tensor is a data structure having multiple elements across one or more dimensions. Examples of tensors include vector (which is one-dimensional (1D) tensor), matrix (which is two-dimensional (2D) tensor), three-dimensional (3D) tensors, four-dimensional (4D) tensors, and even higher dimensional tensors. A dimension of a tensor may correspond to an axis, e.g., an axis in a coordinate system. A dimension may be measured by the number of data points along the axis. The dimensions of a tensor may define the shape of the tensor. A DNN layer may receive one or more input tensors and compute an output tensor from the one or more input tensors. In some embodiments, a 3D tensor may have an X-dimension, a Y-dimension, and Z-dimension. The X-dimension of a tensor may be the horizontal dimension, the length of which may be the width of the tensor; the Y-dimension may be the vertical dimension, the length of which may be the height of the tensor; and the Z-dimension may be the channel dimension, the length of which may be the number of channels. The coordinates of the elements along a dimension may be integers in an inclusive range from 0 to (L-1), where L is the length of the tensor in the dimension. For instance, the x coordinate of the first element in a row may be 0,the x coordinate of the second element in a row may be 1, and so on. Similarly, the γ coordinate of the first element in a column may be 0, the γ coordinate of the second element in a column may be 1, and so on. A 4D tensor may have a fourth dimension, which may indicate the number of batches in the operation.

The deployment and execution of DNN models are typically carried out on general-purpose graphics processing units (GPUs), neural processing units (NPUs), and central processing units (CPUs). While GPUs, NPUs, and CPUs can provide the computational horsepower needed to handle these sophisticated models, they come with significant drawbacks, including high power consumption and latency issues. These limitations become especially problematic in environments where real-time processing and power efficiency are critical, such as in mobile devices, edge computing, and Internet of Things (IoT) applications. Many DNN models, including those based on the transformer architecture, are deployed on GPUs or NPUs. These models, which include large language models (LLMs) and other advanced applications, often face limitations related to power consumption and latency. As an example, Whisper (also referred to as “Whisper model” from herein) is an advanced speech recognition model based on an encoder-decoder transformer architecture. Whisper excels in converting speech to text and vice versa but suffers from the same issues when running on GPUs, NPUs or CPUs.

One issue is high latency. The versatility of GPUs, NPUs and CPUs in executing various computations introduces latency. This latency can be more pronounced in models that necessitate sequential processing, where each step relies on the completion of the previous one, as commonly seen in speech recognition tasks. This bottleneck can hinder the achievement of real-time performance, which is essential for applications like live speech translation, real-time communication systems, and interactive voice interfaces.

Another issue is power inefficiency. GPUs, NPUs and CPUs are known for their high power consumption. This substantial energy requirement not only limits their feasibility in battery-operated devices but also creates significant thermal management challenges. In scenarios where energy efficiency is critical, such as in portable devices, wearable technology, and remote sensing applications, the high-power draw of GPUs can be a substantial disadvantage.

Some currently available solutions are based on traditional general-purpose GPUs. These solutions involve using a standard GPU where model weights are loaded from memory every time an inference task is being performed. While GPUs offer flexibility, allowing them to handle a wide range of tasks, this usually comes at the cost of optimization, power consumption, and latency. This process can consume significant power and time, particularly for complex models. GPUs are typically designed to handle diverse tasks, making them inefficient for dedicated tasks like inference on a pretrained model alone.

To address these issues, some currently available solutions are based on NPUs. NPUs are typically specialized hardware designed explicitly for AI tasks, particularly inference on pretrained models. They can be optimized for the types of computations required in deep learning, such as matrix multiplications and convolutions, and can handle large-scale model weights more efficiently than general-purpose hardware. However, similar to GPUs, even though NPUs can provide flexibility for deep learning tasks, this flexibility usually comes at the expense of optimization, power consumption, and latency.

Some other solutions are based on CPUs for AI inference tasks. DNN models can be loaded on CPUs. However, CPUs are not suitable for large-scale matrix multiplications which are essential for AI inferencing tasks. They can also consume more power and are slower in comparison to dedicated solutions.

Some other solutions are based on dedicated accelerators. Dedicated accelerators are designed specifically for AI training and inference tasks. These accelerators can offer high performance and efficiency for specific AI workloads by optimizing hardware for the unique demands of deep learning computations. They can handle large-scale models and complex operations more effectively than general-purpose hardware. While dedicated accelerators provide unparalleled performance for AI tasks, they require frequent data movement between memory and processing units, which can introduce latency and reduce overall efficiency. This need for data transfer can limit their effectiveness for tasks that require rapid and extensive memory access.

Some other solutions are based on AI processors. These processors can significantly outperform traditional edge AI processors in terms of area and power efficiency. Utilizing a unique, powerful, and scalable structure-driven dataflow architecture, AI processors can take advantage of the core properties of DNNs. This enables edge devices to run deep learning applications at full scale more efficiently, effectively, and substantially than traditional solutions, while significantly lowering costs. Despite their impressive performance and efficiency, AI processors are often optimized for very small models and are not efficient for larger models where data needs to move back and forth from memory, impacting overall performance and efficiency. Also, AI processors typically are not real-time.

Some other solutions are based on Field Programmable Gate Arrays (FPGAs) for AI inference. FPGAs may be programmable hardware that can be customized to perform specific tasks, including loading and handling LLM weights. While FPGAs offer flexibility, they can have significantly lower performance compared to dedicated hardware solutions and are not as power-efficient and not cost effective.

Embodiments of the present disclosure may improve on at least some of the challenges and issues described above by providing hardware embedded inferencing of DNNs. A DNN model (e.g., the model architecture and weights) may be embedded onto an IC device, such as a silicon chip. The IC device may include various units that implement various layers in the DNN. The IC device may execute neural network operations in the DNN with minimal or even no data movement. An example of the DNN is the Whisper model, which utilizes an encoder-decoder architecture for superior speech recognition and transcription capabilities.

In various embodiments of the present disclosure, an IC device implementing a speech recognition model may include an embedder unit, one or more etched mind units, a layer normalizer unit, a sampler unit, and a flow control unit. The embedder unit may be a hardware implementation of an embedder in the model. The embedder unit may include one or more look-up tables and may convert one or more input tokens of the model into an embedding vector. The one or more etched mind units may be a hardware implementation of matrix multiplications and additions in the model. An etched mind unit may include a convolution unit for implementing convolutions, activator units for implementing activation functions, embedding dot units for implementing embedding operations, a first group of memories for storing weights of the embedding operations, attention dot units for implementing attention operations, and a second group of memories for storing key-value cache of the embedding operations. The first group of memories may be dynamic random-access memories (DRAMs) or read-only memories (ROMs). The second group of memories may be static random-access memories (SRAMs). An activator unit may include a look-up table pre-configured with pre-computed data to improve efficiency of the model. The layer normalizer unit may implement a layer normalizer in the model, which may be arranged between encoders and decoders of the model. The sampler unit may implement a sampler in the model. The sampler unit may receive a vector from the etched mind unit(s) and use comparators to find the largest value of the vector. The sampler unit may determine the index of the largest value and output a token. The token may be a prediction of the model. The token may be used as an input token for the next inference process of the model, from which the model may predict another token. The flow control unit may orchestrate the embedder unit, one or more etched mind units, layer normalizer unit, and sampler unit based on a timing sequence of the speech recognition model.

Compared with currently available approaches, the approach in this disclosure has various advantages. One advantage is real-time computing. The power efficiency and performance boost offered by the approach in this disclosure can make it ideal for edge computing, mobile, and IoT applications where resources are limited and low latency is required. Real-time speech-to-text and text-to-speech capabilities can become feasible, enabling use cases such as live transcription services, virtual assistants, real-time translation, and interactive voice response systems. The ability to process speech in real-time can open up new possibilities for user interaction and automation.

Another advantage is performance boost. By hardcoding the Whisper model's weights and architecture onto the chip, the time and power required to load these weights from memory are eliminated. This direct integration of model parameters into the silicon can remove the need for data transfer between memory and processing units. Consequently, inference tasks can be executed faster, providing a significant performance boost. Additionally, the optimized matrix multiplication unit and 1D convolution unit can ensure rapid and efficient processing of data, further enhancing performance. This is particularly beneficial for real-time speech-to-text and text-to-speech applications where low latency is crucial.

Another advantage is power efficiency. The approach in this disclosure can reduce power consumption by eliminating the need to repeatedly load weights and models from memory for each inference task. By embedding the Whisper model directly onto the chip, it can eliminate the need for memory access operations. The use of specialized hardware modules, such as Sequential Read Memory (which powers on the needed next line) and Look-Up Table-based GELU activation and SoftMax function, contributes to lower power usage for edge devices, where power efficiency is paramount, this reduction in power consumption is crucial. This makes the solution more power-efficient, reducing overall operational cost and making it a more environmentally friendly solution.

The approach in this disclosure can also be cost effective. Unlike general-purpose GPUs or NPUs, these dedicated chips are specifically designed to handle AI inference tasks. They do not carry any overhead of unnecessary or general-purpose functionalities, making the solution more cost effective. The tailored design for speech-to-text and text-to-speech applications can ensure that resources are utilized efficiently, providing a cost advantage over more generalized hardware solutions.

The approach in this disclosure can further provide scalability. Due to the encapsulation of specialized Whisper models on multiple chips and the use of a token interface, the system may require very low bandwidth per inference task into the System on Chip (SoC). Multiple SoCs can be connected in parallel to simultaneously handle numerous batches of inference requests with low overhead, enhancing scalability. This can make the solution adaptable for various scales of deployment, from small devices to large-scale server environments.

The approach in this disclosure can also provide security. As the models and weights are hardcoded into the hardware, model integrity can be assured and less susceptible to manipulation, enhancing security. This can be particularly important for applications requiring secure and reliable real-time speech processing, such as in financial services, healthcare, and other sensitive industries.

By embedding Whisper on hardware, the approach in this disclosure can achieve real-time text-to-speech and speech-to-text capabilities with optimized performance. This hardware optimization can not only reduce power consumption but also significantly lower latency, making it ideal for applications requiring immediate response times. This approach can ensure that the model operates efficiently, providing real-time performance without the drawbacks associated with GPU-based execution. By embedding Whisper on silicon, this approach can achieve a seamless integration of speech recognition capabilities into a wide range of devices, from mobile phones to edge computing systems, ultimately enhancing user experience and expanding the potential applications of speech recognition technology.

For purposes of explanation, specific numbers, materials and configurations are set forth in order to provide a thorough understanding of the illustrative implementations. However, it can be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations are described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

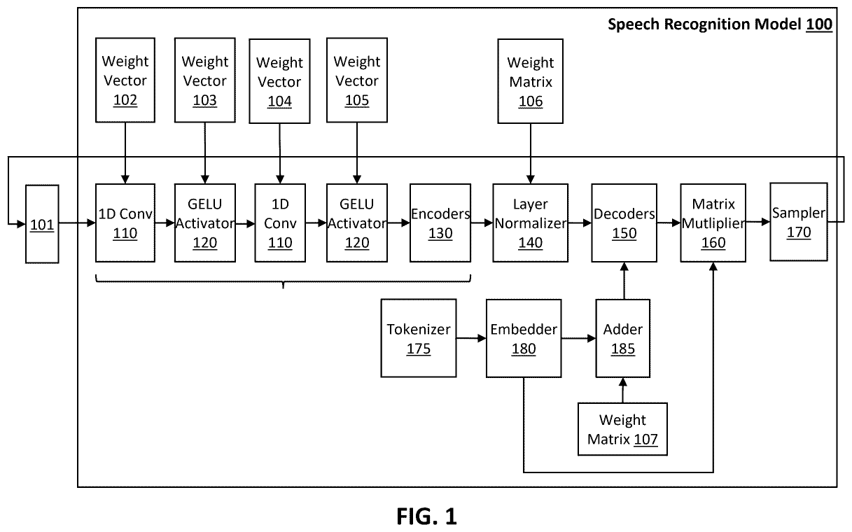

FIG. 1 illustrates exemplary data flow in a speech recognition model 100, in accordance with various embodiments. The speech recognition model 100 may be an encoder-decoder transformer model with speech processing capabilities. In some embodiments, the speech recognition model 100 may have been trained to handle one or more tasks, such as speech recognition, speech translation, language identification, other types of speech processing tasks, or some combination thereof. In some embodiments, the speech recognition model 100 may receive audio as input and may output audio, text, or other types of signals. An example of the speech recognition model 100 is the Whisper model.

As shown in FIG. 1, the speech recognition model 100 includes a embedder 101, 1Dconvolution operators 110 (individual referred to as “1D convolution operator 110” or “1D conv 110”), GELU activators 120 (individual referred to as “GELU activator 120”), encoders 130, layer normalizer 140, decoders 150, matrix multiplier 160, sampler 170, tokenizer 175, text embedder 180, and adder 185. Each one of these components may be a layer or part of a layer of the speech recognition model 100. In other embodiments, the speech recognition model 100 may include fewer, more, or different components. Also, the arrangement of the components in the speech recognition model 100 may be different.

In some embodiments, the speech recognition model 100 may receive an input audio. The embedder 101 may split the input audio into a plurality of chunks. A chunk may be an audio segment of a predetermined or fixed duration of time, such as 30 seconds. The embedder 101 may convert the chunks into a log-Mel spectrogram. The log-Mel spectrogram may be a spectrogram that uses the Mel scale for frequency representation and a logarithmic scale for amplitude representation.

The log-Mel spectrogram is then provided to a 1D conv 110. The 1D conv 110 may perform a 1D convolution on the log-Mel spectrogram and a weight vector 102. The log-Mel spectrogram may be represented by a matrix. In an example, the spatial size of the matrix may be 80×3,000, and the spatial size of the weight vector 102 may be 3,072, meaning the weight vector 102 has 3,072 weights. The output tensor of the 1D convolution is provided to a GELU activator 120. The output tensor of the 1D convolution may be a vector, the spatial size of which may be 3,072,000 for the example described above. The GELU activator 120 applies a weight vector 103 on output tensor of the 1D convolution by using a GELU activator function. In an example, the spatial size of the weight vector 103 may be 1,536,000. The output tensor of the GELU activator function may be a vector, the spatial size of which may be 3,072,000 for the example described above. The output tensor of the GELU activator function and a weight vector 104 are provided to another 1D conv 110 for another 1D convolution. In an example, the spatial size of the weight vector 104 may be 3,072. The output tensor of the second 1D convolution may be a vector, the spatial size of which may be 1,536,000. The output tensor of the second 1D convolution and a weight vector 105 are provided to another GELU activator 120. In an example, the spatial size of the weight vector 105 may be 1,536,000. The weight vector 102, weight vector 103, weight vector 104, or weight vector 105 may be denoted as Wₙ. The output of the second GELU activator 120, which may be a vector having a length of 1,536,000, is provided to the encoders 130. Each encoder 130 may receive a vector having a length of 1,536,000 and outputting a vector having a length of 1,536,000. The output of an encoder 130 may be input into the next encoder 130 for further processing.

The output of the encoders 130, which may be a vector having a length of 1,536,000, is provided to the layer normalizer 140. The layer normalizer 140 also receives a weight matrix 106 and performs layer normalization on the output of the encoders 130 and the weight matrix 106. The weight matrix 106 may be denoted as W_{cls}. The weight matrix 106 may include two weight vectors. The spatial size of the weight matrix 106 may be 1,536,000×2. The layer normalization may be denoted as

$$y = \frac{x - E [ x ]}{\sqrt{Var ( x ) + ϵ}} \times γ + β ,$$

where γ and β are the weights, x is the input, E[x] is the mean of the input, Var(x) is the variance of the input, ϵ is a constant value added for numerical stability, and y is the output.

The output of the layer normalizer 140, which may be a vector having a length of 1,536,000, is provided to the decoders 150. Each decoder 150 may receive a vector having a length of 1,536,000 and outputting a vector having a length of 1,536,000. The output of a decoder 150 may be input into the next decoder 150 for further processing. The decoders 150 may also receive data from the adder 185 for making predictions. As shown in FIG. 1, the tokenizer 175 may receive one or more works and produce one or more tokens from the one or more works. Each token may be represented by a 16-bit integer. The token(s) may then be provided to the text embedder 180. The text embedder 180 may use a look-up table to convert the token to a vector. In an example, the length of the vector may be 1,024. The adder 185 may perform an elementwise addition on the vectors from the text embedder 180 and a weight matrix 107. The weight matrix 107 may be denoted as Wₚₒₛ. In some embodiments, the weight matrix 107 may be a vector that has the same spatial size as the vector from the text embedder 180. The result of the elements addition may be a vector that has the same spatial size as the vector produced by the text embedder 180 or the adder 185. The elementwise addition may be denoted as f(x,y)=x+y, where x may denote each element in the vector produced by the text embedder 180, and γ may denote each element in the vector produced by the adder 185. The result of the elements addition may be provided to the first one of the decoders 150. The decoders 150 can predict text or audio.

The output of the decoders 150 is provided to the matrix multiplier 160. The vector produced by the text embedder 180 is also provided to the matrix multiplier 160. The matrix multiplier 160 may perform a MatMul operation on the output of the decoders 150 and the vectors produced by the text embedder 180. The output of the MatMul operation, which may be a vector, is provided to the sampler 170. The sampler 170 may determine the index of the largest number in the vector from the matrix multiplier 160 and output a token. The token may be represented by a 16-bit integer. The token may be a prediction of the speech recognition model 100. The process of generating the token may be an inference process of the speech recognition model 100. There may be one or more additional inference processes for predicting one or more additional tokens. For instance, to predict the next token, the token is provided to the embedder 101 and may be combined with the initial input to generate a new log-Mel spectrogram, which is then used for another inference process.

The speech recognition model 100 may facilitate various data types. In an example, data in the speech recognition model 100 may have a floating-point data format, such as FP16, BF16,FP32, and so on. As another example, data in the speech recognition model 100 may have an integer format, such as INT5, INT8, INT9, and so on.

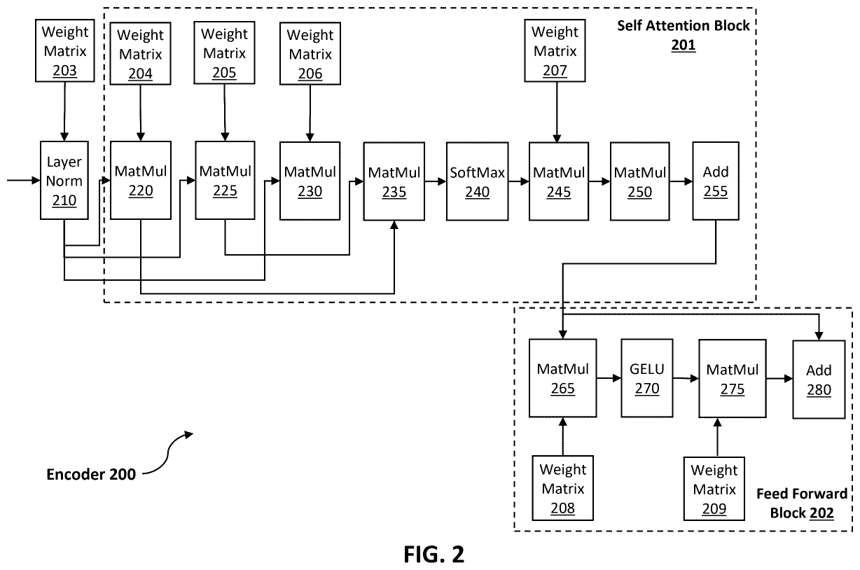

FIG. 2 illustrates an exemplary encoder 200 of a speech recognition model, in accordance with various embodiments. The encoder 200 can efficiently process input speech data through a series of highly optimized neural network operations. The encoder 200 may be an example of the encoders 130 in FIG. 1. As shown in FIG. 2, the encoder 200 includes a layer normalizer 210 (shown as “layer norm” in FIG. 2), MatMul operator 220, MatMul operator 225, MatMul operator 230, MatMul operator 235, SoftMax activator 240, MatMul operator 245, MatMul operator 250, add operator 255, MatMul operator 265, GELU activator 270, MatMul operator 275, and add operator 280. For the purpose of illustration, MatMul operator is shown as “MatMul” in FIG. 2, add operator is shown as “add” in FIG. 2, SoftMax activator is shown as “SoftMax” in FIG. 2, and GELU activator is shown as “GELU” in FIG. 2. In other embodiments, the encoder 200 may include fewer, more, or different components. Also, the arrangement of the components in the encoder 200 may be different.

The layer normalizer 210 can standardizes input vectors. The layer normalizer 210 may perform a layer normalization on an input to the encoder 200 and a weight matrix 203. The weight matrix 203 may include two weight vectors. In an example, the spatial size of the input may be 128,256, and the spatial size of the weight matrix 203 may be 1,024×2. The layer normalization may be denoted as

$$y = \frac{x - E [ x ]}{\sqrt{Var ( x ) + ϵ}} \times γ + β ,$$

where γ and β are the weights, x is the input, E[x] is the mean of the input, Var(x) is the variance of the input, ϵ is a constant value added for numerical stability, and γ is the output. In some embodiments, the weight matrix 203 may be a matrix of root mean square (RMS) attention weights. The layer normalization may be RSM normalization, which can normalize input data elements of the encoder 200 based on the RMS of the activations. The normalization may stabilize the inputs and ensure that the attention weights can be computed on approximately scaled inputs, leading to better training stability and faster convergence. The output of the layer normalizer 310 may be one or more tokens. A token may be represented by a 15-bit integer.

At least some of the MatMul operator 220, MatMul operator 225, MatMul operator 230, MatMul operator 235, MatMul operator 245, MatMul operator 250, MatMul operator 265, and, MatMul operator 275 can handle the transformation and integration of embedding vectors across different layers. As shown in FIG. 2, the output of the layer normalizer 210 is provided to the MatMul operator 220. The MatMul operator 220 performs MatMul on the output of the layer normalizer 210 and a weight matrix 204. The weight matrix 204 may be a matrix of query weights, which may be denoted as W_{Q}. The MatMul result is provided to the MatMul operator 235. The output of the layer normalizer 210 is also provided to the MatMul operator 225. The MatMul operator 225 performs MatMul on the output of the layer normalizer 210 and a weight matrix 205. The weight matrix 205 may be a matrix of key weights, which may be denoted as W K. The MatMul result is provided to the MatMul operator 235. The output of the layer normalizer 210 is further provided to the MatMul operator 230. The MatMul operator 230 performs MatMul on the output of the layer normalizer 210 and a weight matrix 206. The weight matrix 206 may be a matrix of value weights, which may be denoted as W_{V}. In an example, the spatial size of the weight matrix 204, 205, or 206 may be 4,096×4,096. The output of the layer normalizer 210 may be represented by a vector, the length of which may be 4,096. The output of the MatMul operator 220, 225, or 230 may be a vector with a length of 4,096.

The MatMul operator 235 may perform a matrix multiplication on the output of the MatMul operator 220 and the output of the MatMul operator 225 and produce a vector. The vector is then provided to the SoftMax activator 240. The SoftMax activator 240 may apply a SoftMax activation function on the vector. The result of the SoftMax activation function is provided to the MatMul operator 245 for performing another MatMul. The output of the MatMul operator 245, which may be a vector having a length of 4,096, and a weight matrix 207, which may have a spatial size of 4,096×4096 and may be denoted as W_{O}, may be provided to the MatMul operator 250. The MatMul operator 250 may perform a MatMul and produce a vector, the length of which may be 4,096.

The MatMul operator 220, MatMul operator 225, MatMul operator 230, MatMul operator 235, SoftMax activator 240, MatMul operator 245, and MatMul operator 250 constitute a self-attention block 201 of the encoder 200. In the example described above, a 4,096 embedding vector may be split to 16 heads sized 128 each. The self-attention mechanism, utilizing SoftMax function(s), can enable the model to focus on relevant parts of the input sequence, enhancing the accuracy of speech recognition.

The output of the self-attention block 201, which may be a vector having a length of 4,096, is provided to the add operator 255, which may perform an elementwise addition on the output of the self-attention block 201 and input of the encoder 200 and produce a vector, the length of which may be 4,096. The vector is provided to the MatMul operator 265, which may perform a MatMul on the vector and a weight matrix 208. The weight matrix 208 may be denoted as W₁. In an example, the spatial size of the weight matrix 208 is 1,024×4,096. The output of the MatMul operator 265 may be a vector having a length of 4,096. The output of the MatMul operator 265 is provided to the GELU activator 270, which applies a GELU activation function on the output of the MatMul operator 265. The output of the GELU activator 270 may be a vector whose dimension may be 4,096. The vector is provided to the MatMul operator 275, which performs MatMul on the vector and a weight matrix 209. The weight matrix 209 may be denoted as W₂. In an example, the spatial size of the weight matrix 209 is 1,024×4,096. The MatMul operator 275 produces a vector, the dimension of which may be 1,024. The vector is provided to the add operator 280, which performs an elementwise addition on the vector and the output of the add operator 255 and produces a new vector, the dimension of which may be 1,024. The new vector may be the output of the encoder 200.

The MatMul operator 265, GELU activator 270, and MatMul operator 275 constitutes a feed forward block 202 of the encoder 200. The feed forward block 202 may also be referred to as a feed forward DNN. The feed forward block 202 can ensure rapid and effective data processing. This architecture can allow the Whisper encoder to achieve high performance and low latency, making it ideal for real-time speech-to-text applications.

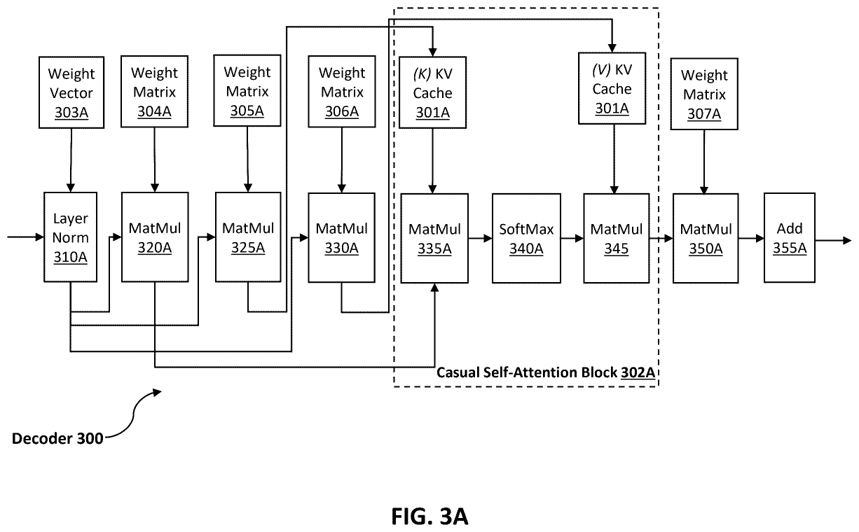

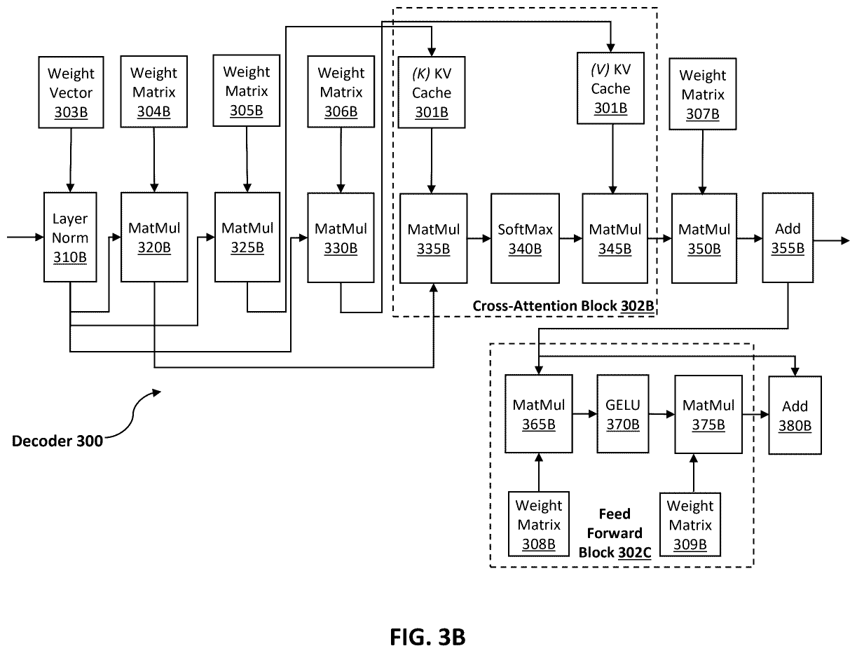

FIGS. 3A and 3B illustrate an exemplary decoder 300 of a speech recognition model, in accordance with various embodiments. The decoder 300 can efficiently transform encoded speech data back into text through a series of sophisticated neural network operations. The decoder 300 may be an example of the decoders 150 in FIG. 1. FIG. 3A shows a part of the decoder 300, and FIG. 3B shows the other part of the decoder 300. As shown in FIG. 3A, the decoder 300 includes a layer normalizer 310A (shown as “layer norm” in FIG. 3A), MatMul operator 320A, MatMul operator 325A, MatMul operator 330A, MatMul operator 335A, SoftMax activator 340A, MatMul operator 345A, MatMul operator 350A, and add operator 355A. For the purpose of illustration, MatMul operator is shown as “MatMul” in FIGS. 3A and 3B, add operator is shown as “add” in FIGS. 3A and 3B, SoftMax activator is shown as “SoftMax” in FIGS. 3A and 3B, and GELU activator is shown as “GELU” in FIGS. 3A and 3B.

The layer normalizer 310A may perform a layer normalization on an input to the decoder 300 and a weight matrix 303A. The weight matrix 303A may include two weight vectors. In an example, the spatial size of the input may be 128,256, and the spatial size of the weight matrix 303A may be 1,024×2. The layer normalization may be denoted as

$$y = \frac{x - E [ x ]}{\sqrt{Var ( x ) + ϵ}} \times γ + β ,$$

where γ and β are the weights, x is the input, E[x] is the mean of the input, Var(x) is the variance of the input, ϵ is a constant value added for numerical stability, and γ is the output. In some embodiments, the weight matrix 303A may be a matrix of RMS attention weights. The layer normalization may be RSM normalization, which can normalize input data elements of the decoder 300 based on the RMS of the activations. The normalization may stabilize the inputs and ensure that the attention weights can be computed on approximately scaled inputs, leading to better training stability and faster convergence. The output of the layer normalizer 310A may be one or more tokens. A token may be represented by a 15-bit integer.

The output of the layer normalizer 310A is provided to the MatMul operator 320A. The MatMul operator 320A performs MatMul on the output of the layer normalizer 310A and a weight matrix 304A. The weight matrix 304A may be a matrix of query weights, which may be denoted as W_{Q}. The MatMul result is provided to the MatMul operator 335A. The output of the layer normalizer 310A is also provided to the MatMul operator 325A. The MatMul operator 325A performs MatMul on the output of the layer normalizer 310A and a weight matrix 305A. The weight matrix 305A may be a matrix of key weights, which may be denoted as W K. The MatMul result is added to a key-value (KV) cache 301A as new key(s). The output of the layer normalizer 310A is further provided to the MatMul operator 330A. The MatMul operator 330A performs MatMul on the output of the layer normalizer 310A and a weight matrix 306A. The weight matrix 306A may be a matrix of value weights, which may be denoted as Wy. The MatMul result is added to a KV cache 301A as new value(s). In an example, the spatial size of the weight matrix 304A, 305A, or 306A may be 4,096×4,096. The output of the layer normalizer 310A may be represented by a vector, the length of which may be 4,096. The output of the MatMul operator 320A, 325A, or 330A may be a vector with a length of 4,096.

The MatMul operator 335A may perform a matrix multiplication on the output of the MatMul operator 320A and the output of the MatMul operator 325A, which may be retrieved from the KV cache 301, and produce a vector. The vector is then provided to the SoftMax activator 340A. The SoftMax activator 340A may apply a SoftMax activation function on the vector. The result of the SoftMax activation function is provided to the MatMul operator 345A for performing another MatMul. The output of the MatMul operator 345A, which may be a vector having a length of 4,096, and a weight matrix 307A, which may have a spatial size of 4,096×4096 and may be denoted as W_{O}, may be provided to the MatMul operator 350A. The MatMul operator 350A may perform a MatMul and produce a vector, the length of which may be 4,096. The MatMul operator 335A, SoftMax activator 340A, and MatMul operator 345A constitute a casual self-attention block 302A of the decoder 300. In the example described above, a 4,096 embedding vector may be split to 16 heads sized 128 each.

As shown in FIG. 3B, the decoder 300 further includes a layer normalizer 310B (shown as “layer norm” in FIG. 3B), MatMul operator 320B, MatMul operator 325B, MatMul operator 330B, MatMul operator 335B, SoftMax activator 340B, MatMul operator 345B, MatMul operator 350B, and add operator 355B, MatMul operator 365, GELU activator 370, MatMul operator 375, and add operator 380. In other embodiments, the decoder 300 may include fewer, more, or different components. Also, the arrangement of the components in the decoder 300 may be different.

The layer normalizer 310B may perform a layer normalization on an input to the decoder 300 and a weight matrix 303B. The weight matrix 303B may include two weight vectors. In an example, the spatial size of the input may be 128,256, and the spatial size of the weight matrix 303B may be 1,024×2. The layer normalization may be denoted as

$$y = \frac{x - E [ x ]}{\sqrt{Var ( x ) + ϵ}} \times γ + β ,$$

where γ and β are the weights, x is the input, E[x] is the mean of the input, Var(x) is the variance of the input, ϵ is a constant value added for numerical stability, and γ is the output. In some embodiments, the weight matrix 303B may be a matrix of RMS attention weights. The layer normalization may be RSM normalization, which can normalize input data elements based on the RMS of the activations. The normalization may stabilize the inputs and ensure that the attention weights can be computed on approximately scaled inputs, leading to better training stability and faster convergence. The output of the layer normalizer 310B may be one or more tokens. B token may be represented by a 15-bit integer.

The output of the layer normalizer 310B is provided to the MatMul operator 320B. The MatMul operator 320B performs MatMul on the output of the layer normalizer 310B, which may be a 1,024 vector, and a weight matrix 304B, which may be a 1,024×1,024 matrix. The weight matrix 304B may be a matrix of query weights, which may be denoted as W_{Q}. The MatMul result, which may be a 1,024 vector, is provided to the MatMul operator 335B.

The MatMul operator 325B receives the output of the add operator 355A and a weight matrix 305B. The weight matrix 305B may be a matrix of key weights, which may be denoted as W_{K}. The MatMul result is added to a KV cache 301B as new key(s). The MatMul operator 330B receives the output of the add operator 355A and a weight matrix 306B. The weight matrix 306B may be a matrix of value weights, which may be denoted as Wy. The MatMul result is added to a KV cache 301B as new value(s). In an example, the spatial size of the weight matrix 305B or weight matrix 306B may be 4,096×4,096. The output of the MatMul operator 325B or MatMul operator 330B may be represented by a vector, the length of which may be 4,096.

The MatMul operator 335B may perform a matrix multiplication on the output of the MatMul operator 320B and the output of the MatMul operator 325B, which may be retrieved from the KV cache 301B, and produce a vector. The vector is then provided to the SoftMax activator 340B. The SoftMax activator 340B may apply a SoftMax activation function on the vector. The result of the SoftMax activation function is provided to the MatMul operator 345B for performing another MatMul. The MatMul operator 335B, SoftMax activator 340B, and MatMul operator 345B constitute a cross-attention block 302B of the decoder 300. In the example described above, a 1,024 embedding vector may be split to 16 heads sized 64 each.

The output of the MatMul operator 345B, which may be a vector having a length of 4,096, and a weight matrix 307B, which may have a spatial size of 4,096×4096 and may be denoted as W_{O}, may be provided to the MatMul operator 350B. The MatMul operator 350B may perform a MatMul and produce a vector, the length of which may be 4,096. The output of the MatMul operator 350B is provided to the add operator 355B, which may perform an elementwise addition on the output of the MatMul operator 350B and output of the add operator 355A and produce a vector, the length of which may be 4,096. The vector is provided to the MatMul operator 365B, which may perform a MatMul on the vector and a weight matrix 308B. The weight matrix 308B may be denoted as W₁. In an example, the spatial size of the weight matrix 308B is 1,024×4,096. The output of the MatMul operator 365B may be a vector having a length of 4,096.

The output of the MatMul operator 365B is provided to the GELU activator 370B, which applies a GELU activation function on the output of the MatMul operator 365B. The output of the GELU activator 370B may be a vector whose dimension may be 4,096. The vector is provided to the MatMul operator 375B, which performs MatMul on the vector and a weight matrix 309B. The weight matrix 309B may be denoted as W₂. In an example, the spatial size of the weight matrix 309B is 1,024×4,096. The MatMul operator 375B produces a vector, the dimension of which may be 1,024. The vector is provided to the add operator 380B, which performs an elementwise addition on the vector and the output of the add operator 355B and produces a new vector, the dimension of which may be 4.096. The new vector may be the output of the decoder 300. The MatMul operator 365B, GELU activator 370B, and MatMul operator 375B constitutes a feed forward block 302C of the decoder 300. The feed forward block 302C may also be referred to as a feed forward DNN.

In the embodiments of FIGS. 3A and 3B, the decoder 300 starts with a layer normalizer to standardize the input vectors, followed by multiple MatMul operators that facilitate the transformation and integration of the data across different layers. The decoder 300 utilizes causal self-attention and cross-attention mechanisms, employing SoftMax functions to focus on relevant parts of the sequence, ensuring accurate text generation. The KV cache may store key and value pairs, enhancing the efficiency of the attention mechanism. The processed data then passes through a GELU activation function and additional MatMul operators within a feedforward neural network, ensuring rapid and precise data processing. This advanced architecture allows the Whisper decoder unit to achieve high performance and low latency, making it ideal for real-time speech-to-text applications.

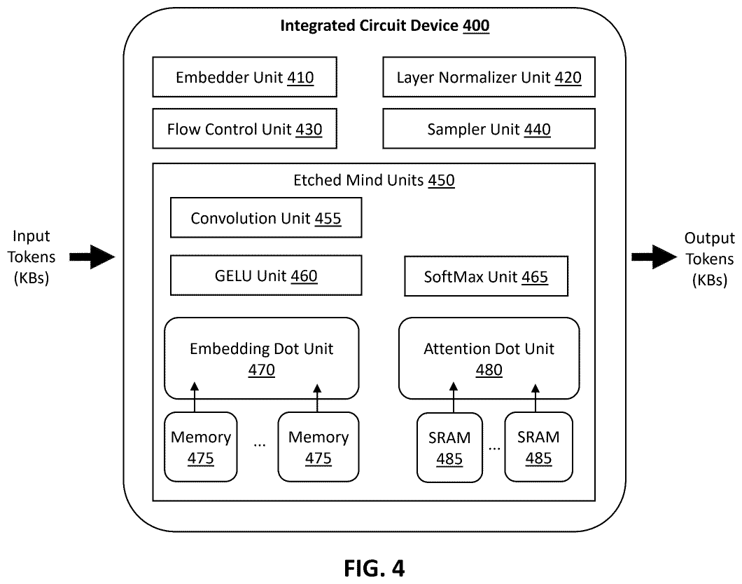

FIG. 4 illustrates an IC device 400 that implements a speech recognition model on silicon, in accordance with various embodiments. The IC device 400 may embed inference of the speech recognition model. The IC device 400 can provide and implement at least a part of the speech recognition model in a single chip, such as a silicon chip. As shown in FIG. 4, the IC device 400 receives tokens in and outputs tokens out. The entire architecture, weights, and flow of the speech recognition model can be embedded into the IC device 400.

The IC device 400 includes an embedder unit 410, layer normalizer unit 420, flow control circuit 430, sampler circuit 440, and etched mind unit 450. The etched mind unit 450 includes a convolution unit 455, GELU unit 460, SoftMax unit 465, embedding dot unit 470, and attention dot unit 480. A unit in the IC device 400 may be a circuit or may include multiple circuits. In other embodiments, the IC device 400 may include fewer, more, or different components. For instance, the IC device 400 may include more than one embedder unit 410, layer normalizer unit 420, flow control unit 430, sampler unit 440, etched mind unit 450, convolution unit 455, GELU unit 460, SoftMax unit 465, embedding dot unit 470, or attention dot unit 480. Further, functionality attributed to a component of IC device 400 may be accomplished by a different component included in the IC device 400 or a different device.

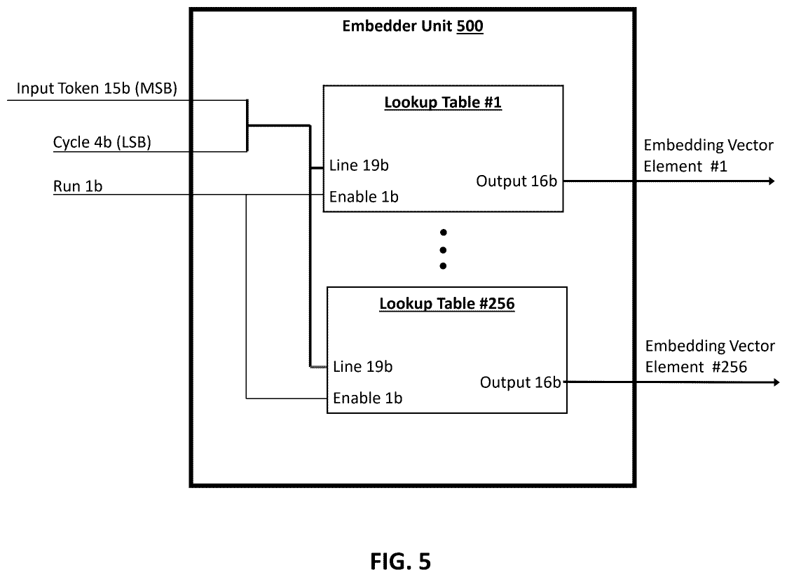

The embedder unit 410 may implement an embedder (e.g., an embedding layer) in the speech recognition module. An example of the embedded is the embedder 101 of the speech recognition model 100 in FIG. 1. The embedder unit 410 may execute the embedding layer to convert input tokens to embedding vectors. In some embodiments, the embedder unit 410 may include look-up tables that map vocabulary of the speech recognition model to embedding elements. The look-up tables may output embedding elements corresponding to the input tokens. The embedding elements may constitute the embedding vector of the input tokens. Certain aspects of the embedder unit 410 are described below in conjunction with FIG. 5.

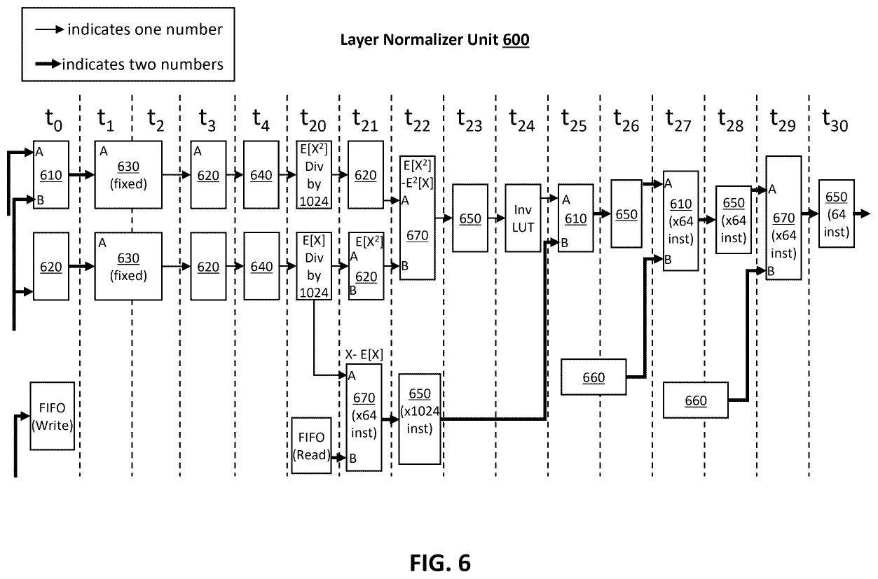

The layer normalizer unit 420 is a hardware implementation of one or more layer normalizers in the speech recognition model, such as the layer normalizer 140 in FIG. 1, layer normalizer 210 in FIG. 2, layer normalizer 310A in FIG. 3A, and layer normalizer 310B in FIG. 3B. The layer normalizer unit 420 may include one or more multipliers, adders (e.g., tree adders), data converters (e.g., fixed-to-float converter or float-to-fixed converter), other compute units, or some combination thereof. The layer normalizer 140 may include or be coupled with sequential read memories (e.g., sequence read ROMs) that store weights to be used by the layer normalizer unit 420 to perform layer normalization. Certain aspects of the layer normalizer unit 420 are described below in conjunction with FIG. 6.

The flow control unit 430 plays a role in orchestrating various circuits to execute operations according to a predetermined timing sequence. The flow control unit 430 may also be referred to as a sequencer unit, which can orchestrate one or more other components of the IC device 400 according to a predetermined timing sequence of the speech recognition model. The speech recognition model may operate in a feedforward manner. The sequence of operations of the model corresponding to different layers of the neural network can be determined and mapped into a timing sequence of neural network operations, including layer normalization, convolution, MatMul, activation function, and so on. The timing sequence of neural network operations may include stages of operations, one following another. In a particular time slot or stage in the timing sequence, data can be moved in, processed, and moved out to be processed in the next/following time slot, in a feedforward, progressive manner. The flow control unit 430 may implement digital logic to generate clock edges/signals (e.g., control signals, timing signals, enable signals, disable signals, trigger signals, etc.) to orchestrate operations to be performed according to the timing sequence. The flow control unit 430 may control data flow into or out of one or more other components of the IC device 400. The flow control unit 430 may also enable or disable one or more other components of the IC device 400 according to a predetermined timing sequence.

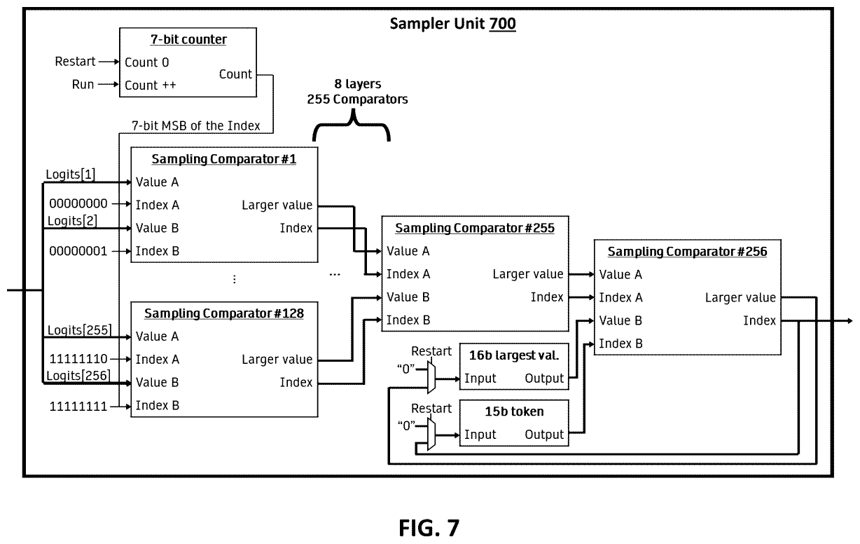

The sampler unit 440 is a hardware implementation of one or more samplers in the speech recognition model, such as the sampler 170 in FIG. 1. The sampler unit 440 may receive an input vector and compare elements of the input vector to find the largest value. The sampler unit 440 may determine the index of the largest number and return a token. Certain aspects of the sampler unit 440 are described below in conjunction with FIG. 7.

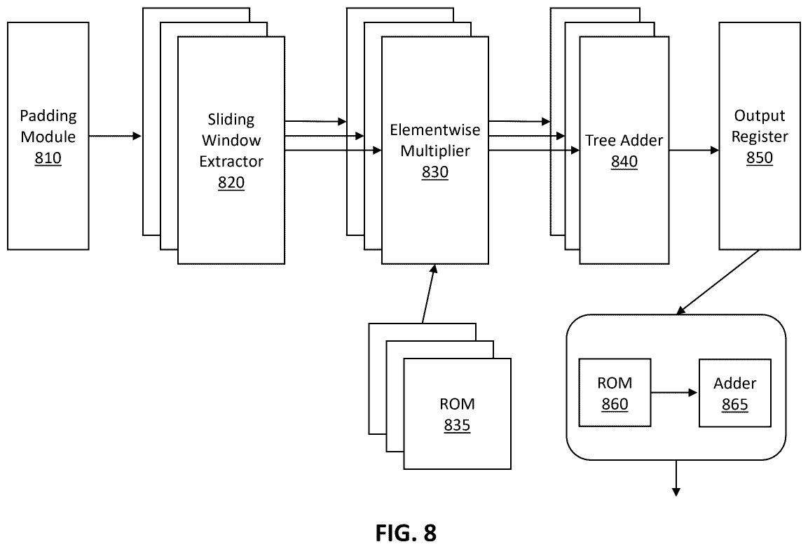

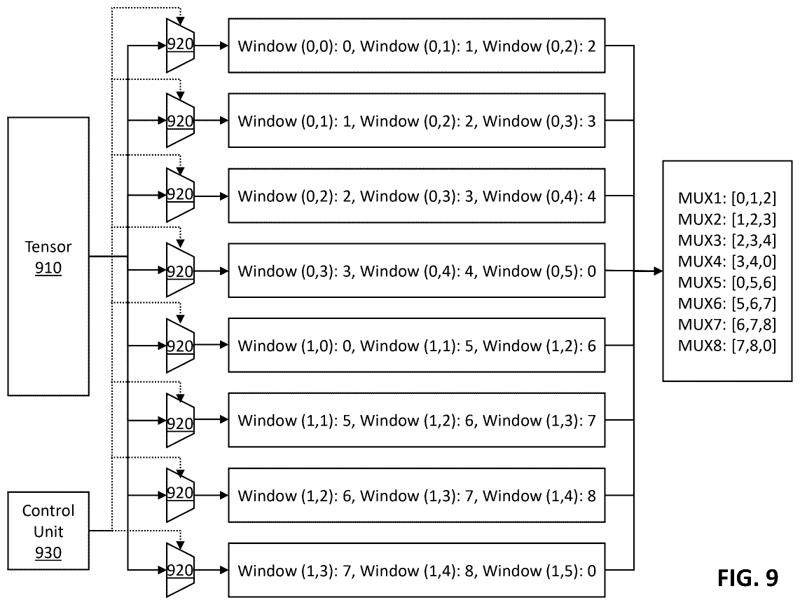

The etched mind unit 450 is a hardware implementation of other layers or neural network operations in the speech recognition model. The convolution unit 455 implements convolutions in the speech recognition model, such as 1D convolutions. The convolution unit 455 may be a hardware implementation of the 1D conv 110 in FIG. 1. Certain aspects of the convolution unit 455 are described below in conjunction with FIG. 8 and FIG. 9.

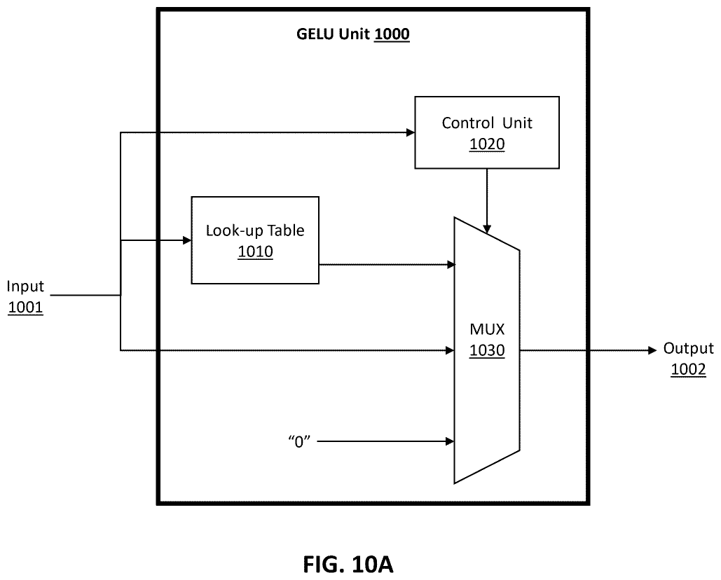

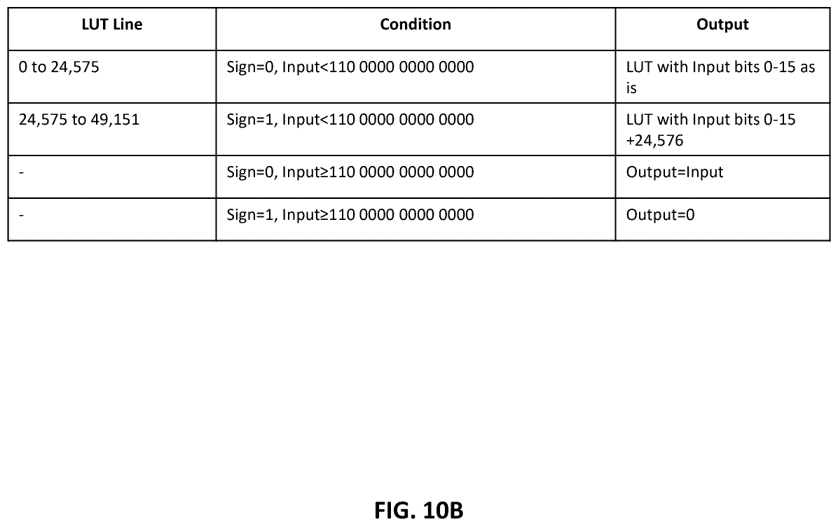

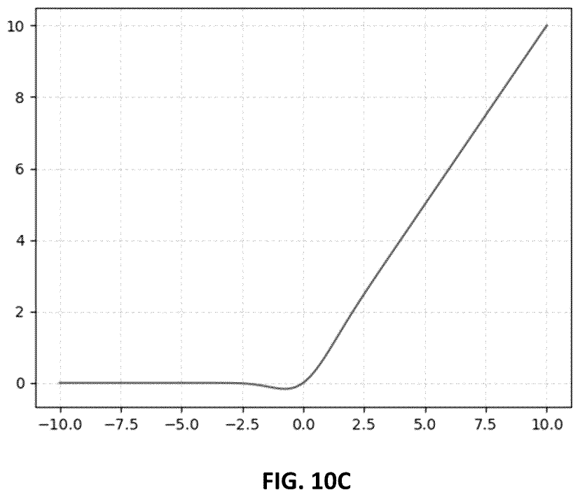

The GELU unit 460 is a hardware implementation of one or more GELU activators in the speech recognition model. For instance, the GELU unit 460 may implement the GELU activators 120 in FIG. 1, the GELU activator 270 in FIG. 2, and the GELU activator 370B in FIG. 3B. The GELU unit 460 may execute a GELU activation function using one or more look-up tables that are pre-configured with pre-computed data. Certain aspects of the GELU unit 460 are described below in conjunction with FIGS. 10A-10C.

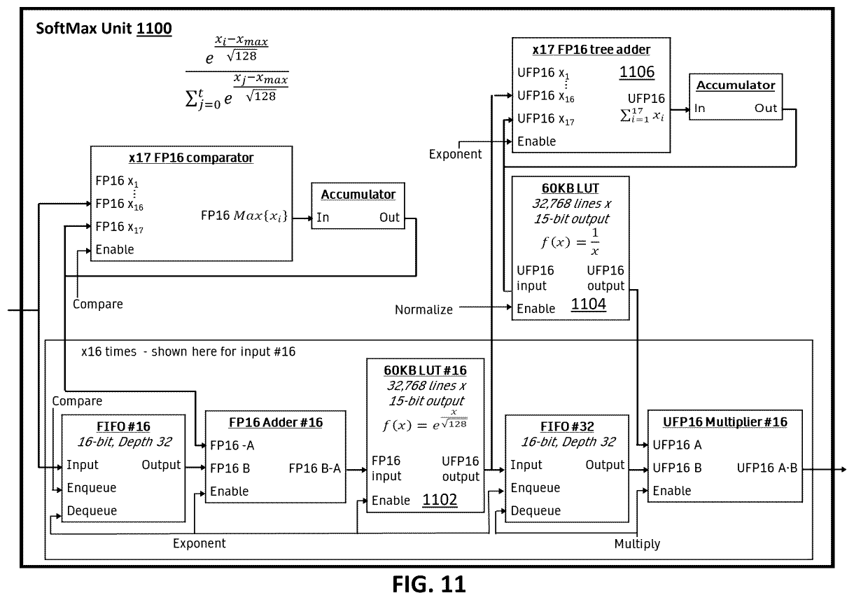

The SoftMax unit 465 is a hardware implementation of one or more SoftMax activators in the speech recognition model. For instance, the SoftMax unit 465 may implement the SoftMax activator 240 in FIG. 2, the SoftMax activator 340A in FIG. 3A, and the SoftMax activator 340B in FIG. 3B. The SoftMax unit 465 may execute a SoftMax function using one or more look-up tables that are pre-configured with pre-computed data. Certain aspects of the SoftMax unit 465 are described below in conjunction with FIG. 11.

The embedding dot unit 470 is a hardware implementation of MatMul operators and add operators in the speech recognition model, such as the MatMul operators and add operators in the encoders of the speech recognition model. For instance, the embedding dot unit 470 may implement some or all of the MatMul operator 220, MatMul operator 225, MatMul operator 230, MatMul operator 235, MatMul operator 245, MatMul operator 250, add operator 255, MatMul operator 265, MatMul operator 275, and add operator 280 in FIG. 2.

The embedding dot unit 470 may include a tree adder and multipliers. The tree adder may also be referred to as an adder tree and may include adders arranged in a tree structure. In one implementation, the embedding dot unit 470 may carry out a (4096-elements) dot product operation between FP8 embedding vector and FP6 weights vector. The dot product operation can be performed using one or more tree adders and one or more multipliers in the embedding dot unit 470. A multiplier may multiple two values, such as two floating-point values. The two values may have different data formats or precisions. For example, the embedding dot unit 470 may include one or more FP4/FP6 multipliers, one or more FP4/FP8 multipliers, or one or more FP6/FP8 multipliers. One or more multipliers in the embedding dot unit 470 may be specifically designed to perform multiplication of values or data having predetermined representations (e.g., FP4, FP6, FP8, FP12, INT8, etc.).

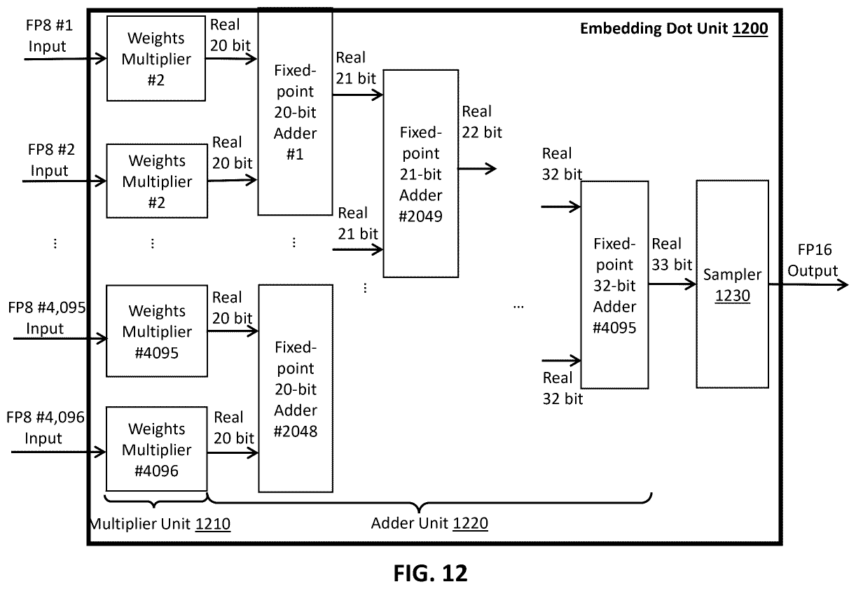

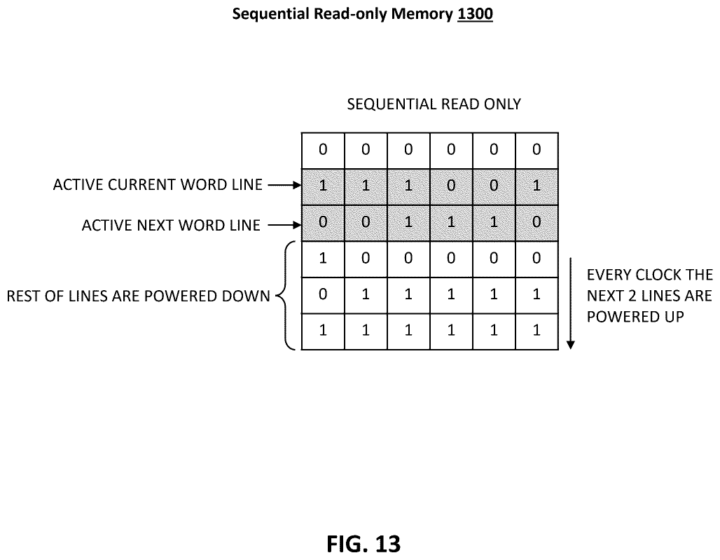

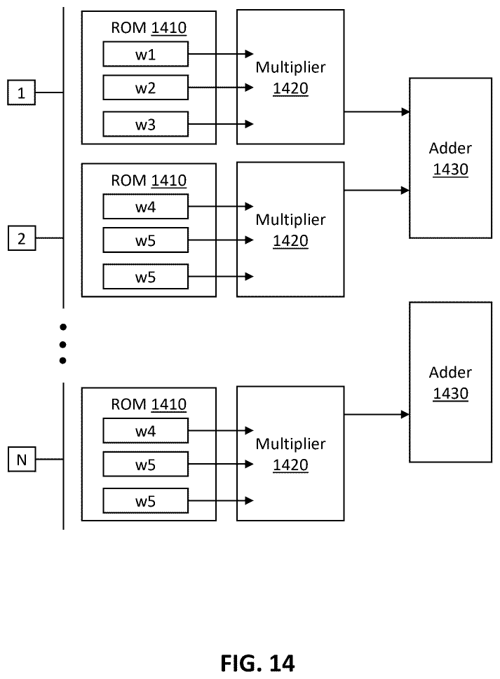

As shown in FIG. 4, the embedding dot unit 470 is coupled with the memories 475. The memories 475 may store and provide data (e.g., weight vector) to the embedding dot unit 470. In some embodiments, the memories 475 may be DRAMs. In other embodiments, the memories 475 may be ROMs, such as sequential read-only memories. The memories 475 may be placed in proximity to the components performing logic operations in the embedding dot unit 470, such as multipliers in the embedding dot unit 470. Each multiplier may be coupled with and proximate to a corresponding memory 475 and may receive data (e.g., one or more weights) from the memory 475. As data is located where it is needed, the embedding dot unit 470 can be very efficient. One or more tree adders may add multiplication results produced by one or more multipliers together. Certain aspects of the embedding dot unit 470 are described below in conjunction with FIG. 12 and FIG. 14. Certain aspects of the memories 475 are described below in conjunction with FIG. 13 and FIG. 14.

The attention dot unit 480 is a hardware implementation of MatMul operators and add operators in the speech recognition model, such as the MatMul operators and add operators in the decoders of the speech recognition model. For instance, the embedding dot unit 470 may implement some or all of the MatMul operator 320A or 320B, MatMul operator 325A or 325B, MatMul operator 330A or 330B, MatMul operator 335A or 335B, MatMul operator 345A or 345B, MatMul operator 350A or 350B, add operator 355A or 355B, MatMul operator 365B, MatMul operator 375B, and add operator 380B in FIGS. 3A and 3B.

In one implementation, the attention dot unit 480 may carry out a (128-elements) dot product operation between FP16 input vector and FP16 K or V vector cached in one or more SRAMs 485, e.g., every cycle. The dot product operation can be performed using one or more tree adders and one or more multipliers in the attention dot unit 480. A multiplier may multiple two values, such as two floating-point values. In an example, the attention dot unit 480 one or more FP16/FP16 multipliers. A multiplier may be specifically designed to perform multiplication of data having predetermined representations (e.g., FP4, FP6, FP8, FP12, FP16, INT8, etc.). One or more multipliers in the attention dot unit 480 may receive data from one or more SRAMs 485. One or more tree adders may add multiplication results produced by one or more multipliers together.

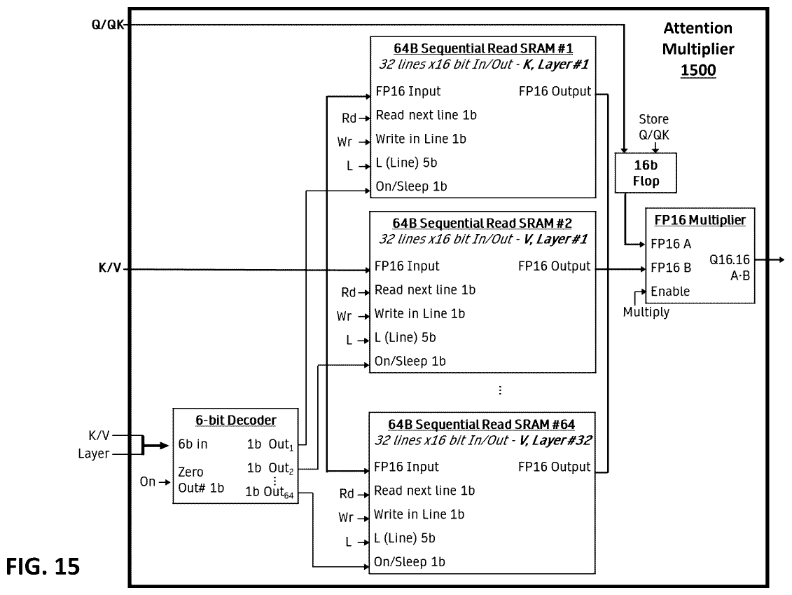

The SRAMs 485 can store and provide data to one or more circuits performing logic operations in the attention dot unit 480. One or more SRAMs 485 may include one or more sequential read/write memories, which may be placed in proximity to the circuits performing logic operations in the attention dot unit 480. For instance, a SRAM 485 may store a KV cache. The KV cache may be dynamic during inference of the speech recognition model. New keys or values may be written into the SRAM 485 as they are generated. Certain aspects of the attention dot unit 480 and one or more SRAMs 485 are described below in conjunction with FIGS. 15.

FIG. 5 illustrates an embedder unit 500, in accordance with various embodiments. The embedder unit 500 may execute an embedding layer of a speech recognition model during inference of the speech recognition model. The embedder unit 500 may be an example of the embedder unit 410 in FIG. 4. As shown in FIG. 5, the embedder unit 500 includes 256 look-up tables. In other embodiments, the embedder unit 500 may include a different number of look-up tables. The look-up tables may have the same storage size, e.g., 1000 KB. Each of the look-up tables may have 512,000 lines. In some embodiments, the look-up tables may be implemented on one or more ROMs. In an example, the 256 look-up tables are implemented on 256 ROMs, respectively.

The embedder unit 500 may receive an input token. In the example shown in FIG. 5, the embedder unit 500 receives an input token represented by 15 bits. The input token may have an integer format. The embedder unit 500 may also receive control signals. For instance, the embedder unit 500 receives an embedder cycle signal (shown as “cycle” in FIG. 5), which may have 4 bits. The embedder unit 500 also receives an embedder run signal (shown as “run” in FIG. 5), which may have 1 bit. Even though not shown in FIG. 5, the embedder unit 500 may also receive an embedder on/off signal, which may have 1 bit.

The output of the embedder unit 500 is an embedding vector of the input token. For instance, the embedder unit 500 may produce an embedding vector with floating-point (e.g., FP16) data elements. The dimension of the embedding vector may indicate the total number of data elements in the embedding vector. In an example, the dimension of the embedding vector may be 4,096. In some embodiments, the embedder unit 500 may receive 32,000 tokens. The total embedder size may be 250 MB, which equals 4,096×32,000×2B. Each of the tokens in the vocabulary may be broken into 16 chunks of 256 numbers. In some embodiments (e.g., embodiments where the look-up tables are stored in ROMs), the first out of 16 numbers may be read from the table. Reading from the ROM may be sequential for 16 cycles, so the next line is to be pre-charged but it may be unnecessary to pre-charge other lines. As shown in FIG. 5, within each cycle, the 256 look-up tables may output 256 embedding vector elements, respectively. The embedder unit 500 may return 256 elements every clock cycle for 16 clocks cycles. After finishing the 16 cycles, the embedder unit 500 may be idle for about 10,000 cycles. Power gating may be used.

FIG. 6 illustrates a layer normalizer unit 600, in accordance with various embodiments. The layer normalizer unit 600 may execute one or more layer normalizers of a speech recognition model during inference of the speech recognition model. Examples of the layer normalizers may include the layer normalizer 210 in FIG. 2, layer normalizer 310A in FIG. 3A, and layer normalizer 310B in FIG. 3B. The layer normalizer unit 600 may be an example of the layer normalizer unit 420 in FIG. 4.

In some embodiments, the layer normalizer unit 600 may perform layer normalization to standardize inputs to a layer, improving training stability and performance. The layer normalizer unit 600 may perform layer normalization by executing a series of mathematical operations on input data, converting between floating-point and fixed-point formats as needed. Layer normalization can improve training stability and performance. In some embodiments, layer normalization may be denoted as:

$$LayerNorm ( x ) = \frac{x - \frac{{\sum }_{j = 0}^{1024} {x}_{j}}{1024}}{\sqrt{\frac{{\sum }_{j = 0}^{1024} {x}_{j}^{2}}{1024} - {( \frac{{\sum }_{j = 0}^{1024} {x}_{j}}{1024} )}^{2} + {10}^{- 5}}} γ + β ,$$

where LayerNorm is layer normalization operation, x is the input vector, xⱼ is an input element with index j, γ is a weight, and β is another weight. In some embodiments,

$$\frac{{\sum }_{j = 0}^{1024} {x}_{j}}{1024}$$

may be the mean of the input vector,

$$\frac{{\sum }_{j = 0}^{1024} {x}_{j}^{2}}{1024} - {( \frac{{\sum }_{j = 0}^{1024} {x}_{j}}{1024} )}^{2}$$

may be the variance, and 10⁻⁵ is a constant used for numerical stability.

The layer normalizer unit 600 includes float-fixed multipliers 610 (individual referred to as “float-fixed multiplier 610”), float-fixed converters 620 (individual referred to as “float-fixed converter 620”), tree adders 630 (individual referred to as “tree adder 630”), accumulators 640 (individual referred to as “accumulator 640”), fixed-float converters 650 (individual referred to as “fixed-float converter 650”), sequential read ROMs 660 (individual referred to as “sequential read ROM 660”), and fixed-fixed adders 670 (individual referred to as “fixed-fixed adder 670”). A float-fixed multiplier 610 can multiply a floating-point number with a fixed number. A float-fixed converter 620 can convert a floating-point number to a fixed number. A fixed-float converter 650 can convert a fixed number to a floating-point number. A fixed-fixed adder 670 can add a fixed number and another fixed number. In some embodiments, a floating-point number computed or received by a component of the layer normalizer unit 600 may be a FP16 number. The layer normalizer unit 600 also includes first-in-first-out (FIFO) buffers for write and read.

In some embodiments, the layer normalizer unit 600 multiplies, accumulates, and processes the data through a sequence of adders, multipliers, and look-up tables, as shown in FIG. 6. It also incorporates FIFO buffers and ROMs for data storage and retrieval, ensuring efficient sequential processing. The entire operation is pipelined architecture designed for high-speed computation. In the example of FIG. 6, the layer normalizer unit 600 may execute layer normalization through 36 cycles. t₀ through t₄ may represent 16 clock cycles.

FIG. 7 illustrates a sampler unit 700, in accordance with various embodiments. The sampler unit 700 is a hardware implementation of a sampler (e.g., the sampler 170 in FIG. 1) of a speech recognition model to return a token corresponding to the largest number in an input vector. The sampler unit 700 may be an example of the sampler unit 440 in FIG. 4.

In some embodiments, the sampler unit 700 may receive a logits vector. In an example, the vector may include 32,000 elements. In some embodiments, the sampler unit 700 may receive 256 input elements for a cycle and may take 125 cycles to process the 32,000. The input elements may be in FP16 format. The total number of bits for the 256 input elements may be 4,096 bits. In some embodiments, the 256 input elements may be received from 256 MatMul units, such as 256 attention dot units, respectively. In some embodiments, the sampler unit 700 may implement a deterministic sampler having zero temperature. The sampler unit 700 may also receive control signals, such as an on/off signal indicating whether the sampler unit 700 is to be on or off, a restart signal indicating whether to restart the sampler unit 700, and a run signal. A control signal may have 1 bit. The sampler unit 700 may determine an index, such as a 32-bit index, corresponding to the largest number in the input vector. The index may correspond to an output token. In some embodiments, the output token may be a 15-bit integer.

As shown in FIG. 7, the sampler unit 700 includes 256 sampling comparators. In other embodiments, the sampler unit 700 may include a different number of sampling comparators. With the 256 sampling comparators, the sampler unit 700 can compare 256 input elements every clock cycle and keeps the index and value of the largest number. Each sampling comparator may compare two logits or values in a single clock cycle and return the larger number of its index (token). Each value may have 16 bits and may be in the FP16 format. The index (token) may be a 15-bit integer. The output may include the larger value as well as the index of the larger value. In a situation where more than one number has the largest value, the sampler unit 700 may return the token with the lowest index out of the equal tokens. When finishing the 125 clock cycles, the sampler unit 700 returns the token of the largest value in the input vector. For instance, the sampler unit 700 may output the index of the largest value in the input vector.

In some embodiments, the sampler unit 700 may have sampling comparators arranged in a tree or hierarchical structure to efficiently compare a large number of values (e.g., hundreds or thousands of values or more) simultaneously. For instance, each comparator in the first tier may compare two values in the input vector and select the larger value, each comparator in the second tier may compare two values from two comparators, respectively, in the first tier, each comparator in the third tier may compare two values from two comparators, respectively, in the second tier, and so on. The last tier may include a comparator that outputs the largest value of the input vector. In some embodiments, the sampler unit 700 may have a latency of 9 clock cycles. Every layer of comparators may be pipeline. In some embodiments, the sampler unit 700 may have power gating.

FIG. 8 illustrates a convolution unit 800, in accordance with various embodiments. The convolution unit 800 may be the hardware implementation of one or more 1D convolution operators (e.g., the 1D conv 110 in FIG. 1) in a speech recognition model during inference of the speech recognition model. The convolution unit 800 may be an example of the convolution unit 455 in FIG. 4.

As shown in FIG. 8, the convolution unit 800 includes an padding module 810, sliding window extractors 820 (individual referred to as “sliding window extractor 820”), elementwise multipliers 830 (individual referred to as “elementwise multiplier 830”), tree adders 840 (individual referred to “tree adder 840”), and an output register 850. In other embodiments, the convolution unit 800 may include fewer, more, or different components.

The padding module 810 may pad an input tensor of a 1D convolution. In some embodiments, the padding module 810 pads the input tensor for edge cases during convolution. The padding module 810 may add one or more zeros into the input tensor. For instance, the padding module 810 may add at least one column of zeros to the left or right of the input tensor. Additionally or alternatively, the padding module 810 may add at least one row of zeros to the top or bottom of the input tensor. After the padding, the input tensor may have a larger spatial size. In an example, the input tensor may be

$$[ \begin{matrix}1 & 2 & 3 & 4 \\ 5 & 6 & 7 & 8\end{matrix} ] ,$$

and the padded tensor may be

$$[ \begin{matrix}0 & 1 & 2 & 3 & 4 & 0 \\ 0 & 5 & 6 & 7 & 8 & 0\end{matrix} ] .$$

The sliding window extractors 820 may scan the padded tensor and generate sliding windows. In an example, the sliding window extractors 820 may extract 3000 windows, the spatial size of each window may be 80×3. For the padded tensor

$$[ \begin{matrix}0 & 1 & 2 & 3 & 4 & 0 \\ 0 & 5 & 6 & 7 & 8 & 0\end{matrix} ] ,$$

a sliding window may be the padded tensor may be

$$[ \begin{matrix}0 & 1 & 2 \\ 0 & 5 & 6\end{matrix} ] .$$

The elementwise multipliers 830 may receive sliding windows extracted by the sliding window extractors 820. In some embodiments, an elementwise multiplier 830 may receive a single window from a corresponding sliding window extractor 820 at a time. The elementwise multipliers 830 may multiply window values with corresponding kernel weights of the convolution. The kernel weight are stored in ROMs 835, individually referred to as “ROM 835.” The ROMs 835 may be sequential read-only memories that are coupled to the elementwise multipliers 830. In some embodiments, the ROMs 835 may be part of the convolution unit 800. In some embodiments, each elementwise multiplier 830 may be coupled to a corresponding ROM 835 and receive weights stored in the corresponding ROM 835. Certain aspects regarding sequential read-only memories are described below in conjunction with FIG. 13.

The convolution, for instance, may have 1024 kernels, the spatial size of each kernel may be 80×3. In an example, an elementwise multiplier 830 may receive a window

$$[ \begin{matrix}0 & 1 & 2 \\ 0 & 5 & 6\end{matrix} ]$$

and a weight tensor

$$[ \begin{matrix}- 0.2344 & - 0.2184 & - 0.1655 \\ 0.0898 & 0.2123 & 0.3474\end{matrix} ] .$$

The elementwise multiplier 830 performs an elementwise multiplication on the window and weight tensor. The elementwise multiplier 830 may multiply each value in the window with a corresponding weight to produce a product. The result of the elementwise multiplication in this example is a matrix

$$[ \begin{matrix}0 & - 0.2184 & - 0.331 \\ 0 & 1.0615 & 2.0844\end{matrix} ] .$$

The tree adders 840 sum the results of the elementwise multiplications performed by the elementwise multiplier 830. In some embodiments, each tree adder 840 may get 240 numbers, which is 80×3. The tree adder 840 may produce a sum of the 240 numbers. In an example where a tree adder 840 receives the matrix

$$[ \begin{matrix}0 & - 0.2184 & - 0.331 \\ 0 & 1.0615 & 2.0844\end{matrix} ] ,$$

the tree adder 840 produces 2.5965, which is the sum of these six numbers. The output of the tree adder 840 may be a matrix, the spatial size of which may be 3000×1024.

The output register 850 receives and stores sums computed by the tree adder 840. The sums may be elements of the output tensor of the convolution. The output register 850 be a register file. The output tensor may be further processed. In some embodiments, a bias may be added to elements of the output tensor. The bias may be stored in a ROM 860. A bias vector with fixed numbers may be formed. The biased vector and the output tensor may be provided to an adder 865. The adder 865 may perform an addition of the bias and the output elements. In some embodiments, the ROM 860 or adder 865 may be part of the convolution unit 800. The structured approach shown in FIG. 8 can ensure the systematic computation of the output tensor while optimizing memory and computational cycles.

FIG. 9 illustrates a sliding window extractor 900 in a convolution unit, in accordance with various embodiments. The sliding window extractor 900 may be an example of the sliding window extractors 820 in FIG. 8. FIG. 9 shows an example in which the sliding window extractor 900 receives a tensor 910. The tensor 910 is

$$[ \begin{matrix}0 & 1 & 2 & 3 & 4 & 0 \\ 0 & 5 & 6 & 7 & 8 & 0\end{matrix} ] .$$

The tensor 910 may be generated by padding an input tensor, e.g., by adding the four zeros to the edges of the input tensor. The sliding window extractor 900 may operate by moving a window of a fixed size across the tensor, extracting overlapping sub-sequences. Each window captures a subset of the tensor 910. In this example, the window size is 1 and each window captures one element. The sliding windows may be implemented using multiplexers (MUXs) 920, individually referred to as “MUX 920.” The MUXs 920 operate under control signals from a control unit 930 to select the right elements from the tensor 910. Window (0,0): 0 in FIG. 9 indicates the position of the first element in the tensor 910, where the first zero indicates the row index of the element and the second zero indicates the column index of the element. The third zero is the value of the first element.

The extracted windows are then directed to additional MUXs (i.e., MUX1 through MUX8 in FIG. 9), which combine these windows into eight new sequences. This process can effectively enable the transformation of the original tensor into multiple overlapping sub-sequences, which can be used for various purposes such as feature extraction in machine learning models. The control unit 930 can orchestrate the movement of the sliding window and the operation of the multiplexers, ensuring the correct sub-sequences are extracted and combined.

FIGS. 10A-10C illustrate a GELU unit 1000, in accordance with various embodiments. The GELU unit 1000 may execute one or more GELU activation functions in a speech recognition model during inference of the speech recognition model. The GELU unit 1000 may be an example of the GELU unit 460 in FIG. 4. FIG. 10A shows an architecture of the GELU unit 1000. FIG. 10B shows outputs of the GELU unit 1000 under different conditions. LUT in FIG. 10B stands for look-up table. FIG. 10C shows a curve representing the GELU activation function executed by the GELU unit 1000.

As shown in FIG. 10A, the GELU unit 1000 includes a look-up table 1010, a control unit 1020, and a MUX 1030. In other embodiments, the GELU unit 1000 may include fewer, more, or different components. The look-up table 1010 may store pre-computed data, such as data computed before inference of the speech recognition model starts. The look-up table 1010 may be configured with the pre-computed data before inference of the speech recognition model starts. The pre-computed data may include data computed using at least part of the GELU activation function. The efficiency of the GELU activator can be improved as the result is read from the look-up table 1010 instead of being calculated in real time. An input 1001 is provided to the look-up table 1010, control unit 1020, and MUX 1030. In some embodiments, the look-up table 1010 may have 49,152 lines and can output 16-bit values. The output values may be results of the GELU activation function, which may be denoted as g (x)=0.5x [1+erf (x/\sqrt{2})],where x is the input 1001. The control unit 1020 may receive most significant bits (MSBs), such as 3-bit MSB, of the input 1001. The output of the control unit 1020 may be a 2-bit control signal. The MUX 1030 may receive three signals: the output of the look-up table 1010, the input 1001, and zero. The MUX 1030 may select one of the three signals based on the control signal from the control unit 1020. In an example, the MUX 1030 selects the input 1001 as its output when sign of the input 1001 is zero and MSB is 11. In another example, the MUX 1030 selects zero as its output when sign is 1 and MSB is 11. In yet another example, the MUX 1030 selects the output of the look-up table 1010 as its output for other situations. The output of the MUX 1030 may be the result of the GELU activation function.

FIG. 11 illustrates a SoftMax unit 1100, in accordance with various embodiments. The SoftMax unit 1100 may be a hardware implementation of one or more SoftMax activators (e.g., the SoftMax activator 240 in FIG. 2, SoftMax activator 340A in FIG. 3A, and SoftMax activator 340B in FIG. 3B) in a speech recognition model during inference of the speech recognition model. The SoftMax unit 1100 may be an example of the SoftMax unit 465 in FIG. 4. The SoftMax unit 1100 may run a SoftMax function, which may be denoted as:

$$\frac{{e}^{\frac{{x}_{i} - {x}_{max}}{\sqrt{128}}}}{{\sum }_{j = 0}^{t} {e}^{\frac{{x}_{j} - {x}_{max}}{\sqrt{128}}}}$$

The SoftMax unit 1100 includes look-up table implementation of the SoftMax function instead of a compute-oriented solution. In some embodiments, the SoftMax unit 1100 receives an input vector of t FP16 elements (1<t<512) and returns the SoftMax normalized vector of the same size. The SoftMax unit 1100 receives 16 numbers per cycle for up to 32 cycles and returns 16 numbers per cycle for up to 32 cycles. In an example, the SoftMax unit 1100 receives an input vector including 16 elements, each of which is a FP16 values, in a clock cycle. The total number of bits of the input vector is 256. The SoftMax unit 1100 may also receive a compare control signal, normalize control signal, exponent control signal, multiply control signal, on/off control signal, other types of control signals, or some combination thereof. A control signal may have 1 bit. The output of the SoftMax unit 1100 may be 16 elements with UFP16 format. The total number bits may be 240. The SoftMax unit 1100 may execute the SoftMax function using 16 clock cycles. Numbers may be stored in a FIFO buffer (e.g., FIFO #16 in FIG. 11) while they are compared to find the largest number in the vector. The FIFO buffer may output numbers. The largest number may be subtracted. The subtraction result is provide to a look-up table (LUT #16 for example). The output of the look-up table enters a second FIFO (e.g., the FIFO #32 in FIG. 11). Numbers may be pulled out of the second FIFO and multiplied by the normalization value. It may take a total of 24 cycles to compute the output. The 24 cycles may include 8 latency cycles and 16 piping cycles.

In some embodiments, the SoftMax unit 1100 may be included in attention dot unit to perform SoftMax on an input vector (e.g., FP16 vector) and to output a SoftMax-ed vector (e.g., FP16 vector). The SoftMax unit 1100 may include ROM 1102 storing the look-up table comprising one or more pre-computed values of an exponent function:

$$f ( x ) = {e}^{\frac{x}{\sqrt{128}}} .$$

The SoftMax unit 1100 may include another ROM 1104 storing the look-up table comprising one or more pre-computed values of a reciprocal function:

$$f ( x ) = \frac{1}{x} .$$

The SoftMax unit 1100 may include tree adder 1106 to add a number of values (e.g., 18 values) together simultaneously. The architecture of the SoftMax unit 1100 shown in FIG. 11 is an example. The SoftMax unit 1100 may have fewer, more, or different components in other embodiments.

FIG. 12 illustrates an embedding dot unit 1200, in accordance with various embodiments. The embedding dot unit 1200 may execute one or more MaxMut operations in a speech recognition model during inference of the speech recognition model. The embedding dot unit 1200 may be an example of the embedding dot unit 470 in FIG. 4.

As shown in FIG. 12, the embedding dot unit 1200 includes a multiplier unit 1210, an adder unit 1220, and a sampler 1230. In other embodiments, the embedding dot unit 1200 may include fewer, more, or different components. The multiplier unit 1210 may perform elements dot product operation between an embedding vector (e.g., FP8 embedding vector) and a weights vector (e.g., FP6 weights vector read from sequential read-only memory) every cycle. The multiplier unit 1210 includes a plurality of weights multipliers. In an example of FIG. 12, the embedding dot unit 1200 may include 4,096 weights multipliers: weights multiplier #1 through weights multiplier #4,096. The weights multipliers may perform multiplication in parallel. The outputs (e.g., 4096 outputs) may be added together by the adder unit 1220.

In the example of FIG. 12, the adder unit 1220 includes 4,095 adders. These adders are arranged in a tree or hierarchical structures. In some embodiments, the adder unit 1220 may use a special fixed-point adder with a relatively large number of bits (e.g., 20 bits, 21 bits, . . . 32 bits). The 4,095 adders may be arranged in 12 tiers. A tier is a level in the tree structure. The first tier includes 2,048 adders, for instance. Each adder in the first tier sums two products from two weights multipliers, respectively. Each adder in the second tier sums the outputs of two adders in the first tier. Each adder in the third tier sums the outputs of two adders in the second tier. This continues till adder #4095 is reached. The adder in the 12^{th} tier outputs the final sum, which may be a 33-bit number, which is then provided to the sampler 1230. The sampler 1230 may be a FP16 sampler. The sampler 1230 may resample the final sum into a floating-point representation. The embedding dot unit 1200 may generate an FP16 output. Using a large number of bits in the adder unit 1220 can prevent overflow during many stages/layers of adding.

FIG. 13 illustrates a sequential read-only memory 1300, in accordance with various embodiments. Sequence read-only memory is a type of memory storage, utilizing ROMs, that allows data to be read sequentially but not written or modified after the values have been etched onto the ROM. The rest of the ROM can be shut down to reduce power and area. In some embodiments, the sequential read-only memory 1300 may be a memory in an IC device implementing a DNN, such as the IC device 400 in FIG. 4. The IC device may include multiple sequential read-only memories. The sequential read-only memory 1300 may be an example of the memories 475 in FIG. 4.

For the purpose of illustration, the sequential read-only memory 1300 in FIG. 13 has six word lines. The sequential read-only memory 1300 can power up an active current word line and an active next word line at a time, while other word lines can be powered down. The active current word line refers to the word line having data being used or processed by a circuit to perform an operation during a time slot in the predetermined timing sequence. The active next word line refers to the word line having data being used or processed by the circuit to perform an operation during a further/next time slot in the predetermined timing sequence. The sequential read-only memory 1300 can power down the rest of the word lines, or the rest of the word lines in the sequential read-only memory 1300 can remain powered down. At the next clock or time slot, the active current word line is powered down, the active next word line is already powered up, and a further active next word line is powered up. At every clock or time slot, two word lines may be powered up in the sequential read-only memory 1300. The two active word lines that are powered up may get moved by one word line down the sequential read-only memory at every clock or time slot.

In some embodiments, one or more sequential read-only memories may be provided on the chip to store various weight matrices for a transformer model:

| Num. Lines | Layer | Matrix |
|---|---|---|
| 16 | 0 | W_{Q} |
| 4 | 0 | W_{K} |
| 4 | 0 | W_{V} |
| 16 | 0 | W_{O} |
| 112 | 0 | W₁ |
| 56 | 0 | W₂ |
| . . . | . . . | . . . |
| 16 | 31 | W_{Q} |
| 4 | 31 | W_{K} |
| 4 | 31 | W_{V} |
| 16 | 31 | W_{O} |
| 112 | 31 | W₁ |
| 56 | 31 | W₂ |
| 16 | 31 | W_{Q} |
| 501 | — | W_{cls} |

In some embodiments, an IC device implementing a DNN may have 1,048,576 ROMs (e.g., sequential read-only memories) for storing weights. A ROM may hold weights in FP6 format. A ROM output may be a 6-bit value. A weights ROM may hold a specific weight matrix column, since a weights ROM can output a single number out of the 4096-element vector being multiplied in the EDU. A weights ROM may hold one of 256 weight matrix rows, e.g., when there are 256 embedding dot units working in parallel and producing 256 numbers per clock cycle. A ROM may hold matrix rows 1, 257, . . . , and another ROM can hold matrix rows 2, 258,and so forth. In some cases, a weights ROM may hold elements from (all) weights matrices in (all) layers, since a weights ROM sequentially outputs the number the matrix multiplier is using for (all) transformers and matrices, as the weights multipliers are shared across all layers and weights matrices. The weights ROM may hold (only) the linear layers' weights. There may be one or more dedicated ROMs for the embedder unit and layer normalizer unit.

FIG. 14 illustrates sequential ROMs proximate to multipliers, in accordance with various embodiments. For the purpose of illustration, FIG. 14 shows N ROMs 1410, individually referred to as “ROM 1410”. An example of the ROMs 1410 may be the sequential read-only memory 1300 in FIG. 13. Each ROM 1410 stores three weights. Each ROM 1410 corresponds to a multiplier 1420, which receives weights from the ROM 1410. In some embodiments, the ROM 1410 may be integrated with the multiplier 1420. The multiplier 1420 may computer one or more products from the weights. The products computed by two adjacent multipliers are provided to an adder 1430 to compute a sum of the two products. With such a configuration, no RAM or cache is needed. Also, data is located where needed. It can be deterministic. Compared with currently available solutions, each ROM 1410 is physically close to the multiplier 1420 that uses it. DNN inference using such as hardware configuration can be extremely fast as data is located where it is needed.

FIG. 15 illustrates an attention multiplier unit 1500 with a sequential read/write memory, in accordance with various embodiments. The attention multiplier unit 1500 may be part of an attention dot unit, e.g., the attention dot unit 480 in FIG. 4. The attention multiplier unit 1500 may be a hardware implementation of one or more MaxMut operators in a speech recognition model during inference of the speech recognition model.

In the embodiments of FIG. 15, the attention multiplier unit 1500 includes sequential read/write memories. A sequential read/write memory may involve using an SRAM in a special configuration that it is not dynamically readable but is built up sequentially to reduce power and area. As shown in FIG. 15, the sequential read/write memories in the attention multiplier unit 1500 are sequential read SRAMs. An SRAM that can be read sequentially or written sequentially has drastically simplified logic and circuitry for reads or writes. A sequential read/write memory can be used with or in an attention dot unit to supply weights to the attention multiplier unit 1500. In one implementation, the attention dot unit having the attention multiplier unit 1500 may receive an input number and multiplies it by a number from SRAM (e.g., sequential read/write memory) every clock cycle. 64 SRAMs may be used to store the 32 layers and K vs. V separately, so the SRAM can read lines sequentially.

According to one aspect, the sequential read/write memory may be referred to as Key-Value Static Random-Access Memory (KV SRAM), which can store data in key-value pairs. KV SRAM can enable storing the attention history (e.g., cached keys and values) of a transformer block. In some embodiments, the attention dot unit may receive an input number and multiplies it by a number from SRAM in every clock cycle. 64 SRAMs are used to store the 32 layers and K vs. V separately, so the SRAM can read lines sequentially.

In some embodiments, a sequential read/write memory may store a KV cache for the speech recognition model. To improve computational efficiency, one or more KV caches can be included on chip with the additional dot unit(s) to enhance the performance of the model by temporarily storing frequently accessed data. Keys and values computed in the attention mechanism can be cached to allow for rapid retrieval of information. In the context of speech recognition models, the key may represent a unique identifier for a specific input or query, while the value may include the corresponding output or computational result. This caching mechanism deals with dynamic data, and thus uses read/write memory, such as SRAM. The KV cache can significantly reduce latency and computational overhead by avoiding redundant calculations and data fetching, thereby improving the efficiency and responsiveness of the model during inference. Because the cached keys and values can be written and read sequentially during inference, the SRAM implementation can be simplified by restricting reads and writes to be done in a sequential manner (obviating circuits that allow for random-access).

In some embodiments, the queries, keys, or values may be FP16 values. The attention multiplier unit 1500 may receive a K/V control signal, layer control signal, SRAM read control signal, SRAM write control signal, SRAM line to write control signal, store Q/QK control signal, on/sleep control signal, other types of control signals, or some combination thereof. The attention multiplier unit 1500 may operate under the control signals. For instance, the decoder may turn on one of the 64 SRAMs based on the layer control signal (which may indicate which layer is being executed) and K/V control signal (which may indicate whether to multiply K or V). A control signal may have 1 bit. In an example where there are 16 attention dot units per head, 32 lines may be used. The output of the attention multiplier unit 1500 may be 32-bit numbers, such as 32-bit fixed-point so adders can use it. In some embodiments, there may be 65,536 instances of the attention multiplier unit 1500 in the IC device. 65,536 equals 32 heads times 16 dots/heads times 128.

In some embodiments, the attention multiplier unit 1500 is included in an attention dot unit to perform multiplication of two numbers (e.g., FP16 value and FP16 value), where one of the two numbers may be read from the sequential read/write memory storing the KV cache. As illustrated, the attention multiplier unit 1500 includes 64 sequential read SRAMs, and a 6-bit decoder. The decoder may turn on one of the 64 sequential read SRAMs to be used. Data may be read from the active sequential read SRAM serially, e.g., line by line. The data the active sequential read SRAM may be multiplied against the input by the FP16 multiplier. Many instances of attention multiplier unit 1500 may be included in an attention dot unit to perform elementwise multiplication, e.g., in parallel. The multiplication results of the instances of the attention multiplier unit 1500 may be summed by a tree adder to form a vector dot product result. The attention dot unit may perform many vector dot products to form a final matrix multiplication result.

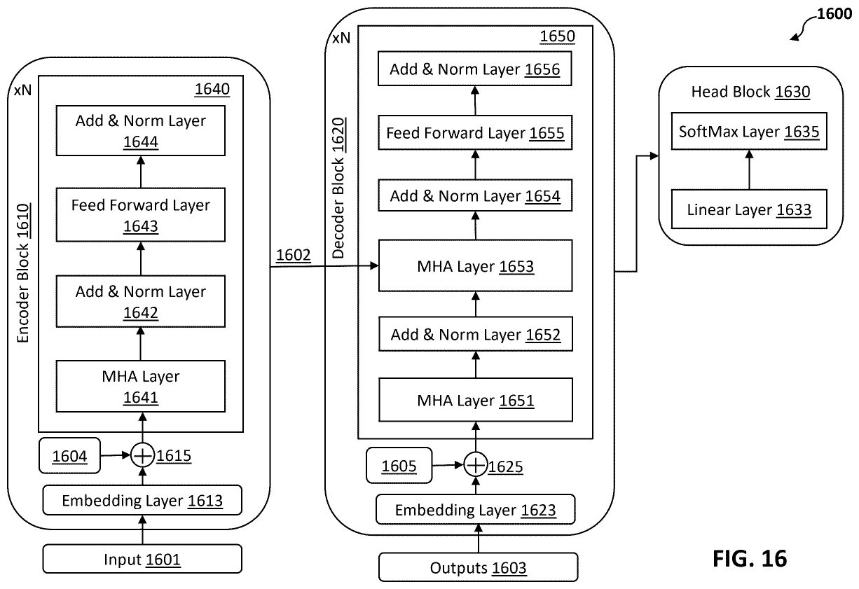

FIG. 16 illustrates an exemplary transformer model 1600, in accordance with various embodiments. The transformer model 1600 may transform input sequences into output sequences. In some embodiments, the transformer model 1600 is a DNN that can learn context and meaning by tracking relationships in sequential data, such as sequential words in a sentence, sequential audio signals, sequential images, and so on. In an example, the transformer model 1600 may be at least part of a speech recognition model, such as the speech recognition models described above. As shown in FIG. 16, the transformer model 1600 includes an encoder block 1610, a decoder block 1620, and a head block 1630. In other embodiment, different or additional components may be included in the transformer model 1600. Further, functionality attributed to a component of the transformer model 1600 may be accomplished by a different component included in the transformer model 1600 or a different model or module.

The encoder block 1610 receives input sequences and generates matrix representations of the input sequences. In the embodiments of FIG. 16, the encoder block 1610 receives an input 1601 and generates an encoder output 1602. The input 1601 may be an input prompt. In some embodiments, the input 1601 may include one or more input tokens, such as words, phrases, sentences, images, audio signals, other types of input tokens, or some combination thereof. In an example, the input 1601 may include a prompt received from a user of the transformer model 1600. The prompt may include a question or request made by the user. A word in the prompt may be an input token. The encoder output 1602 may include one or more vectors that are contextualized representations of the input 1601. Each vector in the encoder output 1602 may represent a token in the input 1601 with contextual understanding.

The encoder block 1610 includes an embedding layer 1613, a positional encoding layer 1615, and a plurality of layers 1640 (individually referred to as “layer 1640”). In other embodiments, the encoder block 1610 may have different, fewer, or more components. Also, the arrangement of the components in the encoder block 1610 may be different from the arrangement shown in FIG. 16. For the purpose of illustration, the encoder block 1610 has N layers in FIG. 16, where N is an integer. Each layer 1640 may include one or more neural network operations. The layers 1640 may transform a sequence of embeddings into a representation that encapsulates the learned information from the input 1601. Different layers 1640 may have different internal parameters, e.g., different weights, bias, or other types of internal parameters. In some embodiments, the layers 1640 have identical components. The components in a layer 1640 may be layers and may also be referred to as sub-layers of the layer 1640. As shown in FIG. 16, a layer 1640 includes four sub-layers: a multi-head attention (MHA) layer 1641, an add & norm layer 1642, a feed forward layer 1643, and another add & norm layer 1644.

The decoder block 1620 iteratively generates outputs 1603 using encoded representations generated by the encoder block 1610. The decoder block 1620 includes an embedding layer 1623, a positional encoding layer 1625, and a plurality of layers 1650 (individually referred to as “layer 1650”). For the purpose of illustration, the decoder block 1620 has N layers in FIG. 16, where N is an integer. In the embodiments of FIG. 16, the number of layers 1650 in the decoder block 1620 is the same as the number of layers 1640 in the encoder block 1610. In other embodiments, the number of layers 1650 in the decoder block 1620 may be different from the number of layers 1640 in the encoder block 1610. Each layer 1650 may include one or more neural network operations. Different layers 1650 may have different internal parameters. In some embodiments, the layers 1650 may have identical components. The components in a layer 1650 may be layers and may also be referred to as sub-layers of the layer 1650. As shown in FIG. 16, a layer 1650 includes six sub-layers: an MHA layer 1651, an add & norm layer 1652, another MHA layer 1653, another add & norm layer 1654, a feed forward layer 1655, and another add & norm layer 1656.

In some embodiments, a sequence of inference stages is performed in the decoder block 1620 using encoder outputs, e.g., the encoder output 1602. A matrix may be predicted through each inference stage. The outputs 1603 may include a plurality of matrices. Each matrix may be further processed in the head block 1630 to predict a token. The plurality of matrices may be used to predict a sequence of tokens. For the first inference stage, the decoder block 1620 may receive one or more start tokens as input tokens and compute a first matrix from the input tokens and the output of the encoder block 1610. The first matrix may be used by the head block 1630 to predict a first token. The predicted token may be used as a new input token, in addition to the start token(s), in the second inference stage. Similarly, a second token may be predicted through the second inference stage and may be used in the third inference stage. This iteration may continue till all the inference stages are complete.

The head block 1630 receives the output of the decoder block 1620 and processes it in a linear layer 1633 and a SoftMax layer 1635. A linear operation may be performed on the output of the decoder block 1620 in the linear layer 1633. The linear operation may include a multiplication of the output of the decoder block 1620 with a weight matrix. The output of the linear layer 1633 may be a vector. In some embodiments, the head block 1630 may function as a classifier. The number of data elements in the vector computed in the linear layer 1633 may depend on the number of classes involved. In an example where there are M classes, where Mis an integer, the vector computed in the linear layer 1633 may have M data elements representing the prediction for the M classes, respectively.

The output of the linear layer 1633 may be input into the SoftMax layer 1635. A SoftMax function may be applied on the output of the linear layer 1633 to compute probability scores. A probability score may have a value in the range from 0 to 16. In some embodiments, a probability value is computed for each data element in the vector computed in the linear layer 1633. The highest one of the probability scores may be the key. The corresponding index of the key may point to the token that the transformer model 1600 predicts as the next in the sequence. The final output of the transformer model 1600 may be the sequence of predicted tokens. In some embodiments, the head block 1630 may be a language modeling head.

An embedding layer (e.g., the embedding layer 1613 or the embedding layer 1623) converts an input of the embedding layer (e.g., the input 1601 or the outputs 1603) into one or more embeddings. An embedding may be a vector, which is also referred to as an embedding vector or a vector embedding. The vector embedding may include a sequence of data elements. In some embodiments, the embedding layer 1613 may generate a plurality of embeddings, each of which may be converted from a different input token in the input 1601. The embeddings may capture the semantic meaning of the tokens in the input 1601. The embeddings may be numerical representations that capture the relationships or meanings of words, phrases, or other data types. In an example where the input 1601 is a prompt including a sequence of words, the embedding layer 1613 may generate an embedding from each word in the input 1601. The embedding layer 1623 in the decoder block 1620 may generate a plurality of embeddings from tokens received by the decoder block 1620 in a similar manner as the embedding layer 1613.

A positional encoding layer (e.g., the positional encoding layer 1615 or the positional encoding layer 1625) performs positional encoding on embeddings generated in the corresponding embedding layer. In some embodiments, the positional encoding layer may apply one or more positional encoding vectors (e.g., a positional encoding vector 1604 or positional encoding vector 1605) on vector embeddings from the corresponding embedding layer to generate new vector embeddings that represent the embeddings with positional context. The positional encoding vector may encode information about the position of the embedding in a sequence of embeddings. In some embodiments, the positional encoding layer performs an addition operation on a positional encoding vector and a vector embedding. The addition operation may be elementwise addition. The positional encoding layer may output an embedding matrix that includes the vector embeddings computed in the positional encoding layer.

An MHA layer (e.g., the MHA layer 1641, the MHA layer 1651, or the MHA layer 1653) may implement a multi-head attention mechanism, which may be a multi-head self-attention mechanism or a multi-head cross-attention mechanism. In some embodiments, the MHA layer 1641 or the MHA layer 1651 may implement a self-attention mechanism. For self-attention, the queries, keys, and values may come from the same place. For instance, for the MHA layer 1641, the queries, keys, and values may all come from the positional encoding layer 1615. For the MHA layer 1651, the queries, keys, and values may all come from the positional encoding layer 1625. The self-attention mechanism may enable the transformer model 1600 to relate each token with other tokens. The MHA layer may compute attention scores from embeddings generated in the corresponding positional encoding layer. In some embodiments, the MHA layer may receive one or more queries, one or more keys, and one or more values. In some embodiments, the MHA layer has a number of heads that receive different linearly projected versions of the queries, keys, and values and produce outputs in parallel that are then used to generate the final result.

In some embodiments, the queries, keys, and values input into the MHA layer 1641 may be computed from vector embeddings generated by the positional encoding layer 1615. The queries, keys, and values input into the MHA layer 1651 may be computed from vector embeddings generated by the positional encoding layer 1625. A query, key, or value may be a vector the represents a token in a sequence. In some embodiments, a query matrix Q∈ [symbol] ^{N×h} may be computed by multiply an embedding matrix X∈ [symbol] ^{N×d} (e.g., an embedding matrix computed in a positional encoding layer) with a weight matrix W_{q}∈ [symbol] ^{d×h}, where d is the dimension of a vector embedding, N is the number of vector embeddings in the embedding matrix, and h is the number of attention heads. Each row in the query matrix may be a query. A key matrix K∈ [symbol] ^{N×h} may be computed by multiple an embedding matrix X∈ [symbol] ^{N×d} (e.g., an embedding matrix computed in a positional encoding layer) with a weight matrix Wₖ∈ [symbol] ^{d×h} Each row in the key matrix may be a key. A value matrix V∈ [symbol] ^{N×h} may be computed by multiple an embedding matrix X∈ [symbol] ^{N×d} (e.g., an embedding matrix computed in a positional encoding layer) with a weight matrix Wᵥ∈ [symbol] ^{d×h}. Each row in the value matrix may be a value.

In some embodiments, the MHA layer 1651 may implement masked multi-head self-attention. The MHA layer 1651 may prevent positions from attending to subsequent positions. For instance, each token in the sequence may not be influenced by future tokens. This masking can ensure that the predictions of a particular position can depend on known outputs at positions before it and not depend on unknown outputs at positions after it.

In some embodiments, the MHA layer 1653 may implement a cross-attention mechanism, such as encoder-decoder cross-attention. The MHA layer 1653 may use outputs from the previous layer (i.e., the add & norm layer 1652) as queries and use outputs from the encoder block 1610 as keys and values. The cross-attention can align the encoder's input with the decoder's, empowering the decoder block 1620 to identify and emphasize the most relevant parts of the encoder's input.

In some embodiments, an MHA layer includes linear layers, a MatMul layer, a scale layer, a SoftMax layer, another MatMul layer, a concatenation layer, and another linear layer. These layers may be arranged in a sequence. The MHA layer may receive three input matrices: a query matrix, a key matrix, and a value matrix, which are inputs of three linear layers, respectively. The linear layers may include matrix multiplication (MatMul) operations. For instance, a first linear layer may perform a multiplication of the query matrix with a weight matrix to compute a first parameter matrix. The first parameter matrix may be denoted as Q WC, where Q is the query matrix and Wᵢ^{Q}∈ [symbol] ^{d}^{_{model}}^{×d}^{_{q}} is the weight matrix. A second linear layer may perform a multiplication of the key matrix with a weight matrix to compute a second parameter matrix. The second parameter matrix may be denoted as KWᵢ^{K}, where K is the key matrix and Wᵢ^{K}∈ [symbol] ^{d}^{_{model}}^{×d}^{ₖ} is the weight matrix. A third linear layer may perform a multiplication of the value matrix with a weight matrix to compute a third parameter matrix. The third parameter matrix may be denoted as VW″, where V is the value matrix and Wᵢ^{V} ∈ [symbol] ^{d}^{_{model}}^{×d}^{ₖ} is the weight matrix. i may indicate the index of the head. d_{q} is the dimension of a query vector. dₖ is the dimension of a key vector. dᵥ is the dimension of a value vector. In some embodiments, d_{q}=dₖ=dᵥ=d_{model}/h. In some embodiments, the linear layers may be in a linear block of the MHA layer. In some embodiments, the MHA layer may include multiple linear blocks. For instance, the MHA layer includes h linear blocks. The linear blocks may have the same layers as each other. Each linear block may compute three parameter matrices from the query matrix, key matrix, and value matrix, respectively.

The MatMul layer, scale layer, mask layer, SoftMax layer, and MatMul layer may be in an attention block of the MHA layer. The attention block may implement a scaled dot product attention mechanism. In some embodiments, the MHA layer includes a plurality of attention blocks that includes the attention block. For the purpose of illustration, the MHA layer includes h attention blocks. The attention blocks may have the same layers as each other. A linear block and an attention block may constitute a head of the MHA layer. When the MHA layer has h linear blocks and h attention blocks, the MHA layer has h heads. A head may be denoted as hea dᵢ=Attention (QWᵢ^{Q}, KWᵢ^{K},VWᵢ^{V}).

A matrix multiplication operation may be performed on parameter matrices in the MatMul layer, which computes a score matrix. In some embodiments, the score matrix may establish the degree of emphasis each token should place on other tokens. The score matrix may include a plurality of scores. Each token may be assigned a score in relation to other tokens within the same time step. A higher score may indicate a higher focus or emphasis. The score matrix may be scaled in the scale layer. In some embodiments, the score matrix is scaled down in the scale layer by dividing the scores in the score matrix by the square root of the dimension of the query vector and the key vector, which may be denoted as \sqrt{dₖ}. The output of the scale layer may be a scaled matrix, which includes adjusted scores. The mask layer may be optional in some embodiments. The mask layer may add an attention mask (which may be an input to the attention block) to the output of the scale layer to mask out some elements in the output of the scale layer. The positions of the masked-out elements may be defined by the attention mask. A SoftMax function may be applied on the scaled matrix in the SoftMax layer to compute an attention weight matrix. The attention weight matrix includes attention weights. The attention weights may be probability values ranging from 0 to 1. The SoftMax function may emphasize high scores while diminishing low scores, which can enhance the model's ability to determine which tokens should get more attention.

In the MatMul layer, a matrix multiplication operation is performed on the attention weight matrix computed in the SoftMax layer and the parameter matrix computed from value matrix in the corresponding linear layer. The result of the matrix multiplication operation is a single-head output matrix, which is an output of the attention block.

When the MHA layer has h attention blocks, there may be h single-head output matrices. The single-head output matrices are concatenated in the concatenation layer to forma concatenated matrix. A linear operation (also referred to as “linear transformation”) is performed on the concatenated matrix using a weight matrix in the linear layer. In some embodiments, the MHA may be denoted as MultiHead (Q,K,V)=Concat (head₁,head₂, . . . , headₕ) W^{O}, where Concat denotes concatenation, and W^{O}∈ [symbol] ^{hd}^{ᵥ}^{×d}^{_{model}} is the weight matrix in the corresponding linear layer.

An add & norm layer in the transformer model 1600, such as the add & norm layer 1642, 1644, 1652, 1654, and 1656, has an addition operation followed by a layer normalization operation. The addition operation may be an addition of the output of the preceding layer and the input of the preceding layer. The preceding layer is a layer that is arranged right before the add & norm layer. For example, the preceding layer of the add & norm layer 1642 is the MHA layer 1641. As another example, the preceding layer of the add & norm layer 1654 is the MHA layer 1653.

Then the layer normalization operation is applied on the result of the addition operation, which may be denoted as LayerNorm (x+sublayer (x)), where LayerNorm denotes layer normalization, x is the input of the preceding layer, and sublayer (x) denotes the output of the preceding layer. In some embodiments, the layer normalization operation may include a sequence of computations. In an example, the layer normalization operation may include a mean computation, which may be denoted as

$${μ}_{x y} = \frac{1}{Z} \times {\sum }_{z = 1}^{Z} {A}_{xyz} ,$$

where A_{xyz} denotes a data element in the input tensor, x may be the positional index of the data element in one of the spatial dimensions, γ may be the positional index of the data element in the other one of the spatial dimensions, z may be the positional index of the data element in the channel dimension, and μ_{xy} denotes the output of the mean computation, which may be a 2D matrix. The mean computation may be channel-wise reduction operation. The layer normalization operation may convert μ_{xy} to a 3D tensor μ_{xyz}, e.g., by replicating every data element over z output points.

The layer normalization operation may also include an elementwise subtraction, which may be denoted as D_{xyz}=A_{xyz}−μ_{xyz}. The layer normalization operation may further include a variance computation denoted as

$${σ}_{x y}^{2} = {\sum }_{z = 1}^{Z} {D}_{xyz}^{2}$$

and a division computation denoted as

$${M}_{x y} = \frac{1}{\sqrt{\frac{1}{Z} \times ( {σ}_{x y}^{2} + ϵ \times Z )}} .$$

M_{xy} may be a 2D tensor. The layer normalization operation may also convert M_{xy} to a 3D tensor M_{xyz}, e.g., by replicating every data element over z output points. Further, the layer normalization operation may have an element multiplication denoted as

$${A}_{x y z}^{′} = \frac{{A}_{x y z} - {μ}_{x y z}}{\sqrt{\frac{1}{Z} \times ( {σ}_{xy}^{2} + ϵ )}} = ( {A}_{x y z} - {μ}_{x y z} ) \times \frac{1}{\sqrt{\frac{1}{Z} \times ( {σ}_{x y}^{2} + ϵ )}} = {D}_{x y z} \times {M}_{x y z} .$$

The layer normalization operation may further compute

$${A}_{x y z}^{″} = {A}_{x y z}^{′} + \frac{{β}_{z}}{{γ}_{z}} and {LN}_{x y z} = {A}_{x y z}^{″} \times {γ}_{z} \cdot {LN}_{x y z}$$

may be the output of the layer normalization operation.

A feed forward layer (e.g., the feed forward layer 1643 and the feed forward layer 1655) may be a position-wise fully-connected feed forward network. In an example, the feed forward layer may include two linear layers with an activation function in between. An example of the activation function is Rectified Linear Unit (ReLU).

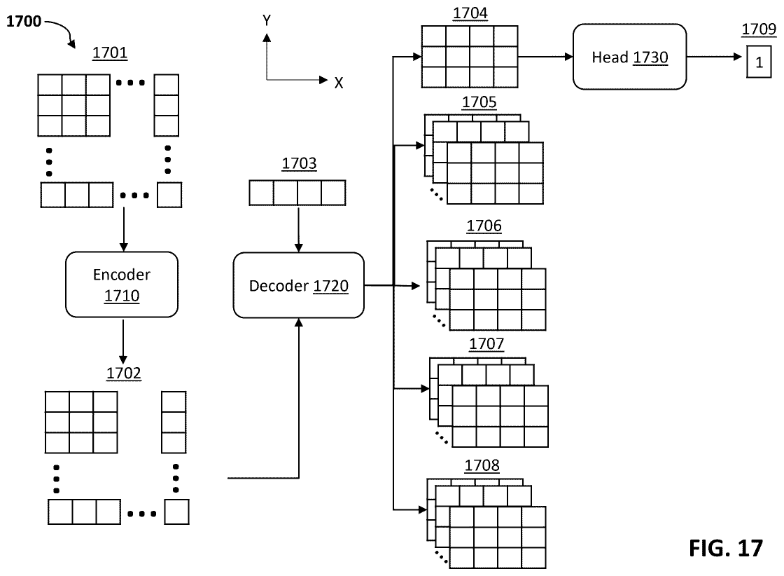

FIG. 17 illustrates a first inference phase of a transformer model 1700, in accordance with various embodiments. The transformer model 1700 includes an encoder 1710, a decoder 1720, and a head 1730. An example of the transformer model 1700 may be the transformer model 1600 in FIG. 16. In the embodiments of FIG. 17, the encoder 1710 receives an input tensor 1701. The input tensor 1701 may be a feature map extracted from one or more images, text documents, audio files, videos, other types of data, or some combination thereof. The encoder 1710 generates an output tensor 1702 from the input tensor 1701. The shape of the output tensor 1702 may be denoted as [batch size, SL_{encoder}, d_{model}], where SL_{encoder} may be the dimension along the X axis (i.e., the width of the output tensor 1702), and d_{model} may be the dimension along the Y axis (i.e., the height of the output tensor 1702). The encoder 1710 may include a plurality of layers arranged in a sequence, such as the layers inside the encoder block 110 in FIG. 1. The output tensor 1702 is provided to the decoder 1720.

The decoder 1720 receives the output tensor 1702 and an input sequence 1703. The input sequence 1703 may be a sequence of tokens. A token may be a numerical representation of an input signal, such as word, image, audio signal, video signal, etc. The dimension of the input sequence 1703, which may be denoted as SLᵢₙₚᵤₜ, may be the total number of tokens in the input sequence 1703. For the purpose of illustration and simplicity, SLᵢₙₚᵤₜ is 4. In other embodiments, the input sequence 1703 may have a different shape. For instance, the input sequence 1703 may be a 2D tensor. The dimension of the 2D tensor along the X axis may be SLᵢₙₚᵤₜ, while the dimension of the 2D tensor along the Y axis may be a batch size indicating the number of batches in the input sequence 1703.

The decoder 1720 computes an output tensor 1704, a self-attention key tensor 1705, a self-attention value tensor 1706, a cross-attention key tensor 1707, and a cross-attention value tensor 1708. In some embodiments, the shape of the output tensor 1704 may be denoted as [batch size, SLᵢₙₚᵤₜ, d_{model}]. The shape of the self-attention key tensor 1705 or the shape of the self-attention value tensor 1706 may be denoted as N×[batch size, h, SLᵢₙₚᵤₜ, d_{head}],where N is the number of identical layers in the decoder (e.g., the number of layers 1650 in the decoder block 1620), h is the total number of heads in a MHA layer, and d_{head} is the dimension of a query vector, key vector, or value vector. In some embodiments, d_{model}=h×d_{head}. The shape of the cross-attention key tensor 1707 or the shape of the cross-attention value tensor 1708 may be denoted as N×[batch size, h, SL_{encoder}, d_{head}].

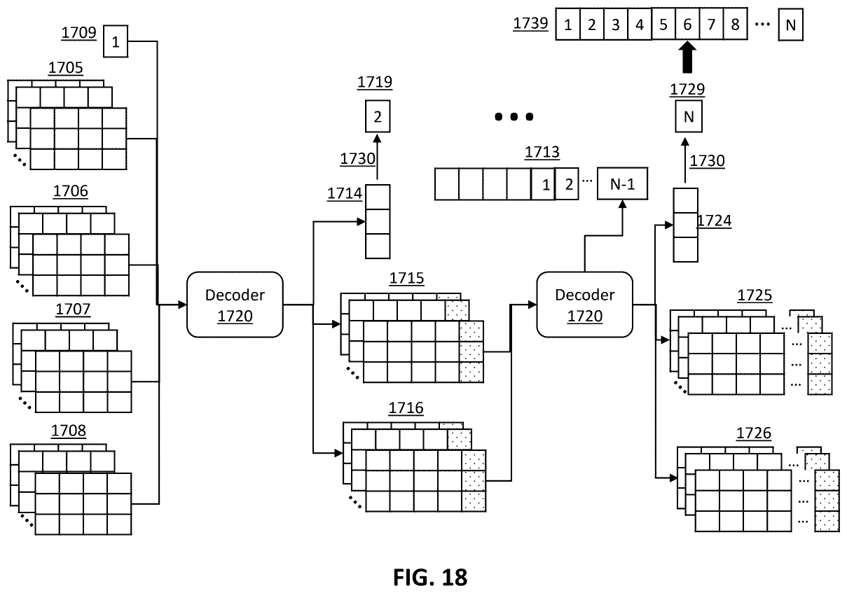

The output tensor 1704 may be provided to the head 1730 and the head 1730 outputs a predicted token 1709. The shape of the token 1709 may be denoted as [batch size, 1]. For the purpose of illustration and simplicity, batch size is 1 in FIG. 17. In other embodiments, batch size may be a larger number. The predicted token 1709 may be stored in a buffer. In some embodiments, the predicted token 1709 may be used to update the input sequence 1703. For instance, the predicted token 1709 may be added to the right of the input sequence 1703. The updated input sequence may be used as the input sequence in the second inference phase. In the second inference phase, the decoder 1720 may receive the updated input sequence and the output tensor 1702 for predicting another token. The output tensor 1702 may remain the same during inference of the decoder 1720. Certain aspects of subsequent inference phases are described below in conjunction with FIG. 18.

In some embodiments, the self-attention key tensor 1705 and the self-attention value tensor 1706 may be provided to a self-attention layer in the decoder 1720, an example of such a self-attention layer is the MHA layer 151. The self-attention key tensor 1705 may be stored in a self-attention key cache. The self-attention key cache may have the same shape as the self-attention key tensor 1705. The self-attention value tensor 1706 may be stored in a self-attention value cache. The self-attention value cache may have the same shape as the self-attention value tensor 1706.

In some embodiments, the decoder 1720 computes the self-attention key tensor 1705 and the self-attention value tensor 1706 from the input sequence 1703. The input sequence 1703 may be dynamic during inference of the decoder 1720. For instance, a new token may be added to the input sequence 1703 after each inference phase, as described above. As the input sequence 1703 changes, the self-attention key tensor 1705 and the self-attention value tensor 1706 would also change. For instance, the dimension of the self-attention key tensor 1705 or the self-attention value tensor 1706 along the X axis may increase as SLᵢₙₚᵤₜ increases. The self-attention key cache and the self-attention value cache may change during all the inference phases of the decoder 1720 to accommodate the changes in the self-attention key tensor 1705 and the self-attention value tensor 1706.

In some embodiments, the cross-attention key tensor 1707 and the cross-attention value tensor 1706 may be provided to a cross-attention layer in the decoder 1720, an example of such a cross-attention layer is the MHA layer 153. The cross-attention key tensor 1707 may be stored in a cross-attention key cache. The cross-attention key cache may have the same shape as the cross-attention key tensor 1707. The cross-attention value tensor 1708 may be stored in a cross-attention value cache. The cross-attention value cache may have the same shape as the cross-attention value tensor 1708. In some embodiments, the decoder 1720 computes the cross-attention key tensor 1707 and the cross-attention value tensor 1706 from the output tensor 1702 generated in the encoder 1710. As the output tensor 1702 does not change during inference of the decoder 1720, the cross-attention key tensor 1707 and the cross-attention value tensor 1706 may remain the same during all the inference phases of the decoder 1720. The cross-attention key cache and the cross-attention value cache may remain the same during all the inference phases of the decoder 1720.

FIG. 18 illustrates subsequent inference phases of the transformer model, in accordance with various embodiments. In the second inference phase, the decoder 1720 may reuse the self-attention key tensor 1705, self-attention value tensor 1706, cross-attention key tensor 1707, and cross-attention value tensor 1708. The decoder 1720 also receives the predicted token 1709. The decoder 1720 may compute self-attention key vectors from the predicted token 1709 and concatenate the self-attention key vectors with the self-attention key tensor 1705 to generate a new self-attention key tensor 1715. For instance, a self-attention key vector for each head may be added to the right of a self-attention key matrix in the self-attention key tensor 1705, and the self-attention key vector and the self-attention key matrix may correspond to the same head. The elements highlighted with a dot pattern in the self-attention key tensor 1715 are the self-attention key vectors generated from the predicted token 1709.

Similarly, the decoder 1720 may compute self-attention value vectors from the predicted token 1709 and concatenate the self-attention value vectors with the self-attention value tensor 1706 to generate a new self-attention value tensor 1716. For instance, a self-attention value vector for each head may be added to the right of a self-attention value matrix in the self-attention value tensor 1706, and the self-attention value vector and the self-attention value matrix may correspond to the same head. The elements highlighted with a dot pattern in the self-attention value tensor 1716 are the self-attention value vectors generated from the predicted token 1709.

The decoder 1720 also generates an output tensor 1714. The decoder 1720 may generate the output tensor 1714 using the new self-attention key tensor 1715 and new self-attention value tensor 1716. The output tensor 1714 is used by the head 1730 to generate another predicted token 1719. The predicted token 1719 is the output of the transformer model 1700 in the second inference phase.

One or more other subsequent inference phases may be conducted. In each subsequent inference phase, the decoder 1720 receives a token predicted in the previous inference phase, a self-attention key tensor generated in the previous inference phase, a self-attention value tensor generated in the previous inference phase, the cross-attention key tensor 1707, and the cross-attention value tensor 1708. The decoder 1720 may, in the subsequent inference phase, generate a larger self-attention key tensor and a larger self-attention value tensor, in addition to an output tensor which can be used by the head 1730 to predict a new token.

In embodiments where the total number of inference phases is N, the input sequence 1703 is updated to an input sequence 1713 after N-1 inference phases. In the last inference phase (i.e., the Nth inference phase), the decoder 1720 may receive the predicted token generated in the (N-1)th inference phase, the self-attention key tensor generated in the (N-1)th inference phase, the self-attention value tensor generated in the (N-1)th inference phase, the cross-attention key tensor 1707, and the cross-attention value tensor 1708. The decoder 1720 may generate a self-attention key tensor 1725 and a self-attention value tensor 1726 using the predicted token generated in the (N-1)th inference phase, the self-attention key tensor generated in the (N-1)th inference phase, and the self-attention value tensor generated in the (N-1)th inference phase. The dimensions of the self-attention key tensor 1725 or self-attention value tensor 1726 along the X axis is SLᵢₙₚᵤₜ+N. The decoder 1720 also generates an output tensor 1724, which is used by the head 1730 to generate the last predicted token 1729. The N tokens predicted by the transformer model in the N inference phases may constitute an output tensor 1739, which may be the final output of the transformer model.

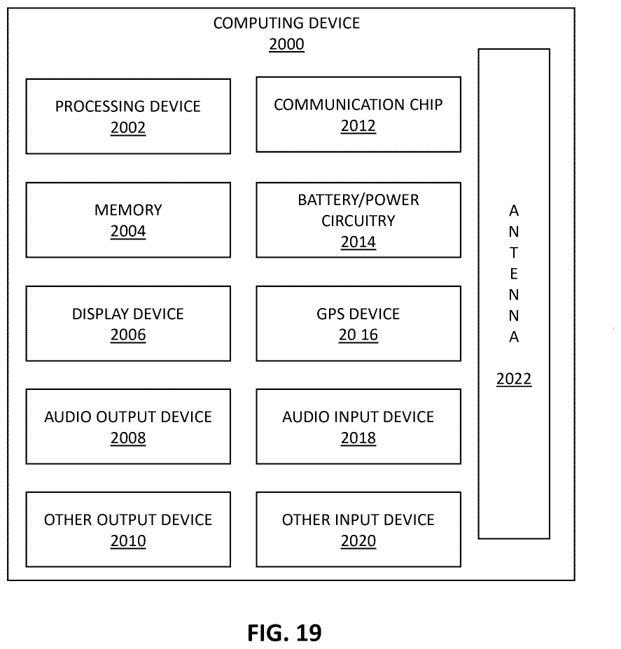

FIG. 19 is a block diagram of an example computing device 2000, in accordance with various embodiments. A number of components are illustrated in FIG. 19 as included in the computing device 2000, but any one or more of these components may be omitted or duplicated, as suitable for the application. In some embodiments, some or all of the components included in the computing device 2000 may be attached to one or more motherboards. In some embodiments, some or all of these components are fabricated onto a single SoC die. Additionally, in various embodiments, the computing device 2000 may not include one or more of the components illustrated in FIG. 19, but the computing device 2000 may include interface circuitry for coupling to the one or more components. For example, the computing device 2000 may not include a display device 2006, but may include display device interface circuitry (e.g., a connector and driver circuitry) to which a display device 2006 may be coupled. In another set of examples, the computing device 2000 may not include an audio input device 2018 or an audio output device 2008 but may include audio input or output device interface circuitry to which an audio input device 2018 or audio output device 2008 may be coupled.

The computing device 2000 may include a processing device 2002 (e.g., one or more processing devices). The processing device 2002 processes electronic data from registers and/or memory to transform that electronic data into other electronic data that may be stored in registers and/or memory. The processing device 2002 may include one or more IC devices implementing speech recognition models, such as the IC device 400 in FIG. 4. The computing device 2000 may include a memory 2004, which may itself include one or more memory devices such as volatile memory (e.g., DRAM), nonvolatile memory (e.g., ROM), high bandwidth memory (HBM), flash memory, solid state memory, and/or a hard drive. In some embodiments, the memory 2004 may include memory that shares a die with the processing device 2002. In some embodiments, the memory 2004 includes one or more non-transitory computer-readable media storing instructions executable to perform operations, such as operations in speech recognition models. The instructions stored in the one or more non-transitory computer-readable media may be executed by the processing device 2002.

In some embodiments, the computing device 2000 may include a communication chip 2012 (e.g., one or more communication chips). For example, the communication chip 2012 may be configured for managing wireless communications for the transfer of data to and from the computing device 2000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 2012 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 2012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 2012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 2012 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 2012 may operate in accordance with other wireless protocols in other embodiments. The computing device 2000 may include an antenna 2022 to facilitate wireless communications and/or to receive other wireless communications (such as AM or FM radio transmissions).

In some embodiments, the communication chip 2012 may manage wired communications, such as electrical, optical, or any other suitable communication protocols (e.g., the Ethernet). As noted above, the communication chip 2012 may include multiple communication chips. For instance, a first communication chip 2012 may be dedicated to shorter-range wireless communications such as Wi-Fi or Bluetooth, and a second communication chip 2012 may be dedicated to longer-range wireless communications such as global positioning system (GPS), EDGE, GPRS, CDMA, WiMAX, LTE, EV-DO, or others. In some embodiments, a first communication chip 2012 may be dedicated to wireless communications, and a second communication chip 2012 may be dedicated to wired communications.

The computing device 2000 may include battery/power circuitry 2014. The battery/power circuitry 2014 may include one or more energy storage devices (e.g., batteries or capacitors) and/or circuitry for coupling components of the computing device 2000 to an energy source separate from the computing device 2000 (e.g., AC line power).

The computing device 2000 may include a display device 2006 (or corresponding interface circuitry, as discussed above). The display device 2006 may include any visual indicators, such as a heads-up display, a computer monitor, a projector, a touchscreen display, a liquid crystal display (LCD), a light-emitting diode display, or a flat panel display, for example.

The computing device 2000 may include an audio output device 2008 (or corresponding interface circuitry, as discussed above). The audio output device 2008 may include any device that generates an audible indicator, such as speakers, headsets, or earbuds, for example.

The computing device 2000 may include an audio input device 2018 (or corresponding interface circuitry, as discussed above). The audio input device 2018 may include any device that generates a signal representative of a sound, such as microphones, microphone arrays, or digital instruments (e.g., instruments having a musical instrument digital interface (MIDI) output).

The computing device 2000 may include a GPS device 2016 (or corresponding interface circuitry, as discussed above). The GPS device 2016 may be in communication with a satellite-based system and may receive a location of the computing device 2000, as known in the art.

The computing device 2000 may include another output device 2010 (or corresponding interface circuitry, as discussed above). Examples of the other output device 2010 may include an audio codec, a video codec, a printer, a wired or wireless transmitter for providing information to other devices, or an additional storage device.

The computing device 2000 may include another input device 2020 (or corresponding interface circuitry, as discussed above). Examples of the other input device 2020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 2000 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 2000 may be any other electronic device that processes data.

The following paragraphs provide various examples of the embodiments disclosed herein.

Example 1 provides an IC device, including one or more memories of a first type; an embedding dot unit to implement one or more operations in an encoder of a speech recognition model, the embedding dot unit coupled with the one or more memories of the first type, and the embedding dot unit including one or more adders and one or more multipliers; one or more memories of a second type; and an attention dot unit to implement one or more operations in a decoder of the speech recognition model, the attention dot unit coupled with the one or more memories of the second type, and the attention dot unit including one or more adders and one or more multipliers.

Example 2 provides the IC device of example 1, in which the one or more memories of the first type are one or more dynamic random-access memories.

Example 3 provides the IC device of example 1, in which the one or more memories of the first type are one or more read-only memories.

Example 4 provides the IC device of any one of examples 1-3, in which the one or more memories of the second type are one or more static random-access memories.

Example 5 provides the IC device of any one of examples 1-4, in which the one or more operations in the encoder include a matrix multiplication operation, and one or more weights of the matrix multiplication operation are stored in the one or more memories of the first type.

Example 6 provides the IC device of any one of examples 1-5, in which the one or more operations in the decoder include a matrix multiplication operation on keys or values, and a KV cache is stored in the one or more memories of the second type.

Example 7 provides the IC device of any one of examples 1-6, further including an activator unit to implement an activation function in the speech recognition model, the activator unit including a look-up table with one or more parameters of the activation function.

Example 8 provides the IC device of example 7, in which the look-up table is configured before an execution of the speech recognition model starts.

Example 9 provides the IC device of any one of examples 1-8, further including a convolution unit to implement a convolution in the speech recognition model, the convolution unit including a sliding window extractor, the sliding window extractor to extract one or more subsets of a tensor of the convolution, and a padding module, in which the tensor is generated by the padding module from an input tensor of the convolution.

Example 10 provides the IC device of any one of examples 1-9, in which the embedding dot unit and the attention dot unit are orchestrated by a flow control unit based on a timing sequence of the speech recognition model.

Example 11 provides an IC device, including an embedder unit including one or more look-up tables, the embedder unit to convert one or more input tokens of a speech recognition model into an embedding vector; one or more etched mind units, an etched mind units including one or more memories of a first type, an embedding dot unit coupled with the one or more memories of the first type, the embedding dot unit including one or more adders and one or more multipliers, the embedding dot unit to execute one or more embedding operations in an encoder of a speech recognition model based on the embedding vector, one or more memories of a second type, and an attention dot unit coupled with the one or more memories of the second type, the attention dot unit including one or more adders and one or more multipliers, the attention dot unit to execute one or more attention operations in a decoder of a speech recognition model; and a sampler unit including one or more comparators, the sampler unit to determine a largest value in a vector received from the one or more etched mind units and to produce an output token based on the largest value.

Example 12 provides the IC device of example 11, in which the one or more memories of the first type are one or more dynamic random-access memories or are one or more read-only memories.

Example 13 provides the IC device of example 11 or 12, in which the one or more memories of the second type are one or more static random-access memories.

Example 14 provides the IC device of any one of examples 11-13, in which the one or more operations in the encoder include a matrix multiplication operation, and one or more weights of the matrix multiplication operation are stored in the one or more memories of the first type.

Example 15 provides the IC device of any one of examples 11-14, in which the one or more operations in the decoder include a matrix multiplication operation on keys or values, and a KV cache is stored in the one or more memories of the second type.

Example 16 provides the IC device of any one of examples 11-15, further including an activator unit to implement an activation function in the speech recognition model, the activator unit including a look-up table with one or more parameters of the activation function.

Example 17 provides the IC device of any one of examples 11-16, further including a convolution unit to implement a convolution in the speech recognition model, the activator unit including a sliding window extractor, the sliding window extractor to extract one or more subsets of a tensor of the convolution.

Example 18 provides an IC device, including an embedder unit including one or more look-up tables, the embedder unit to convert one or more input tokens of a speech recognition model into an embedding vector; one or more etched mind units, an etched mind units including one or more memories and one or more multipliers, the one or more etched mind units to execute matrix multiplication operations in the speech recognition model based on the embedding vector; a sampler unit including one or more comparators, the sampler unit to determine a largest value in a vector received from the one or more etched mind units and to produce an output token based on the largest value; and a flow control unit to orchestrate the embedder unit, one or more etched mind units, and sampler unit based on a timing sequence of the speech recognition model.

Example 19 provides the IC device of example 18, further including a layer normalizer unit to execute a layer normalization operator in the speech recognition model.

Example 20 provides the IC device of example 19, in which the speech recognition model includes one or more encoders and one or more decoders, and the layer normalization is arranged between the one or more encoders and the one or more decoders.

Example 21 provides one or more non-transitory computer-readable media storing instructions executable to perform operations for executing a speech recognition model, the operations including converting, by an embedder unit including one or more look-up tables, one or more input tokens of the speech recognition model into an embedding vector; executing, by one or more etched mind units, matrix multiplication operations in the speech recognition model based on the embedding vector, an etched mind unit including one or more memories and one or more multipliers; determining, by a sampler unit including one or more comparators, a largest value in a vector received from the one or more etched mind units and to produce an output token based on the largest value; and orchestrating, by a flow control unit, the embedder unit, one or more etched mind units, and sampler unit based on a timing sequence of the speech recognition model.

Example 22 provides the one or more non-transitory computer-readable media of example 21, in which the operations further include executing, by a layer normalizer unit, a layer normalization operator in the speech recognition model.

Example 23 provides the one or more non-transitory computer-readable media of example 22, in which the speech recognition model includes one or more encoders and one or more decoders, and the layer normalization is arranged between the one or more encoders and the one or more decoders.

Example 24 provides the one or more non-transitory computer-readable media of any one of examples 21-23, in which the one or more memories include a memory of a first type and a memory of a second type, in which the memory of the first type is a dynamic random-access memory or read-only memory and the memory of the second type is a static random-access memory.

Example 25 provides the one or more non-transitory computer-readable media of example 24, in which executing the matrix multiplication operations includes storing one or more weights of the matrix multiplication operations in the memory of the first type.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art can recognize. These modifications may be made to the disclosure in light of the above detailed description.

1. An integrated circuit (IC) device, comprising:
one or more memories of a first type;
an embedding dot unit to implement one or more operations in an encoder of a speech recognition model, the embedding dot unit coupled with the one or more memories of the first type, and the embedding dot unit comprising one or more adders and one or more multipliers;
one or more memories of a second type; and
an attention dot unit to implement one or more operations in a decoder of the speech recognition model, the attention dot unit coupled with the one or more memories of the second type, and the attention dot unit comprising one or more adders and one or more multipliers.

2. The IC device of claim 1, wherein the one or more memories of the first type are one or more dynamic random-access memories.

3. The IC device of claim 1, wherein the one or more memories of the first type are one or more read-only memories.

4. The IC device of claim 1, wherein the one or more memories of the second type are one or more static random-access memories.

5. The IC device of claim 1, wherein the one or more operations in the encoder comprise a matrix multiplication operation, and one or more weights of the matrix multiplication operation are stored in the one or more memories of the first type.

6. The IC device of claim 1, wherein the one or more operations in the decoder comprise a matrix multiplication operation on keys or values, and a key-value cache is stored in the one or more memories of the second type.

7. The IC device of claim 1, further comprising:
an activator unit to implement an activation function in the speech recognition model, the activator unit comprising a look-up table with one or more parameters of the activation function.

8. The IC device of claim 7, wherein the look-up table is configured before an execution of the speech recognition model starts.

9. The IC device of claim 1, further comprising:
a convolution unit to implement a convolution in the speech recognition model, the convolution unit comprising:
a sliding window extractor, the sliding window extractor to extract one or more subsets of a tensor of the convolution, and
a padding module, wherein the tensor is generated by the padding module from an input tensor of the convolution.

10. The IC device of claim 1, wherein the embedding dot unit and the attention dot unit are orchestrated by a flow control unit based on a timing sequence of the speech recognition model.

11. An integrated circuit (IC) device, comprising:
an embedder unit comprising one or more look-up tables, the embedder unit to convert one or more input tokens of a speech recognition model into an embedding vector;
one or more etched mind units, an etched mind units comprising:
one or more memories of a first type,
an embedding dot unit coupled with the one or more memories of the first type, the embedding dot unit comprising one or more adders and one or more multipliers, the embedding dot unit to execute one or more embedding operations in an encoder of a speech recognition model based on the embedding vector,
one or more memories of a second type, and
an attention dot unit coupled with the one or more memories of the second type, the attention dot unit comprising one or more adders and one or more multipliers, the attention dot unit to execute one or more attention operations in a decoder of a speech recognition model; and
a sampler unit comprising one or more comparators, the sampler unit to determine a largest value in a vector received from the one or more etched mind units and to produce an output token based on the largest value.

12. The IC device of claim 11, wherein the one or more memories of the first type are one or more dynamic random-access memories or are one or more read-only memories.

13. The IC device of claim 11, wherein the one or more memories of the second type are one or more static random-access memories.

14. The IC device of claim 11, wherein the one or more operations in the encoder comprise a matrix multiplication operation, and one or more weights of the matrix multiplication operation are stored in the one or more memories of the first type.

15. The IC device of claim 11, wherein the one or more operations in the decoder comprise a matrix multiplication operation on keys or values, and a key-value cache is stored in the one or more memories of the second type.

16. The IC device of claim 11, further comprising:
an activator unit to implement an activation function in the speech recognition model, the activator unit comprising a look-up table with one or more parameters of the activation function.

17. The IC device of claim 11, further comprising:
a convolution unit to implement a convolution in the speech recognition model, the convolution unit comprising a sliding window extractor, the sliding window extractor to extract one or more subsets of a tensor of the convolution.

18. An integrated circuit (IC) device, comprising:
an embedder unit comprising one or more look-up tables, the embedder unit to convert one or more input tokens of a speech recognition model into an embedding vector;
one or more etched mind units, an etched mind units comprising one or more memories and one or more multipliers, the one or more etched mind units to execute matrix multiplication operations in the speech recognition model based on the embedding vector;
a sampler unit comprising one or more comparators, the sampler unit to determine a largest value in a vector received from the one or more etched mind units and to produce an output token based on the largest value; and
a flow control unit to orchestrate the embedder unit, one or more etched mind units, and sampler unit based on a timing sequence of the speech recognition model.

19. The IC device of claim 18, further comprising:
a layer normalizer unit to execute a layer normalization operator in the speech recognition model.

20. The IC device of claim 19, wherein the speech recognition model comprises one or more encoders and one or more decoders, and the layer normalization is arranged between the one or more encoders and the one or more decoders.

21. One or more non-transitory computer-readable media storing instructions executable to perform operations for executing a speech recognition model, the operations comprising:
converting, by an embedder unit comprising one or more look-up tables, one or more input tokens of the speech recognition model into an embedding vector;
executing, by one or more etched mind units, matrix multiplication operations in the speech recognition model based on the embedding vector, an etched mind unit comprising one or more memories and one or more multipliers;
determining, by a sampler unit comprising one or more comparators, a largest value in a vector received from the one or more etched mind units and to produce an output token based on the largest value; and
orchestrating, by a flow control unit, the embedder unit, one or more etched mind units, and sampler unit based on a timing sequence of the speech recognition model.

22. The one or more non-transitory computer-readable media of claim 21, wherein the operations further comprise:
executing, by a layer normalizer unit, a layer normalization operator in the speech recognition model.

23. The one or more non-transitory computer-readable media of claim 22, wherein the speech recognition model comprises one or more encoders and one or more decoders, and the layer normalization is arranged between the one or more encoders and the one or more decoders.

24. The one or more non-transitory computer-readable media of claim 21, wherein the one or more memories comprise a memory of a first type and a memory of a second type, wherein the memory of the first type is a dynamic random-access memory or read-only memory and the memory of the second type is a static random-access memory.

25. The one or more non-transitory computer-readable media of claim 24, wherein executing the matrix multiplication operations comprises storing one or more weights of the matrix multiplication operations in the memory of the first type.
